(19) United States
(12) Patent Application Publication
(10) Pub. No.: US 2025/0122424 A1
(43) Pub. Date: Apr. 17, 2025

(54) LOW PHONON ENERGY NANOPARTICLES BASED ON ALKALI LEAD HALIDES AND METHODS OF SYNTHESIS AND USE

(71) Applicants: THE REGENTS OF THE UNIVERSITY OF CALIFORNIA, Oakland, CA (US); The Trustees of Columbia University in the City of New York, New York, NY (US); Universidad Autónoma de Madrid, Madrid (ES)

(72) Inventors: Zhuolei Zhang, Berkeley, CA (US); Artiom Skripka, Madrid (ES); P. James Schuck, New York, NY (US); Bruce Cohen, San Francisco, CA (US); Emory Chan, Oakland, CA (US)

(73) Assignees: THE REGENTS OF THE UNIVERSITY OF CALIFORNIA, Oakland, CA (US); The Trustees of Columbia University in the City of New York, New York, NY (US); Universidad Autónoma de Madrid, Madrid (ES)

(21) Appl. No.: 18/908,917

(22) Filed: Oct. 8, 2024

Related U.S. Application Data
(60) Provisional application No. 63/590,166, filed on Oct. 13, 2023.

(51) Int. Cl. C09K 11/77; C01F 17/36; C01G 21/00

(52) U.S. Cl. CPC C09K 11/7773; C01F 17/36; C01G 21/006; C09K 11/7757; C01P 2002/52; C01P 2002/72; C01P 2002/77; C01P 2002/82; C01P 2004/04; C01P 2004/62; C01P 2004/64; C01P 2006/60

(57) ABSTRACT

Phonon engineered, lanthanide doped upconverting nanoparticles with very low phonon energies and tunable methods of synthesis that adjust OA:OM ratio and reaction temperature are provided. Low phonon energy KPb₂X₅ (X=Cl, Br) upconverting nanoparticles, both doped and undoped, exhibit dramatically suppressed multiphonon relaxation, enhancing upconversion emission from higher lanthanide excited states and enabling room temperature observation of avalanche like upconversion by Nd³⁺ ions. Intrinsic optical bistability (IOB) of the materials can provide bit level functionality to all optical computing. The IOB of Nd³⁺ doped nanocrystals, which are either bright or dark at the same excitation power based on power history, illustrate the functionality. High contrast switching and IOB are enabled via the photon avalanche process, which sustains population inversion between the ground and the first excited 4f^{N} states of Nd³⁺ ions. The IOB of these nanocrystals can be controlled by temporal pump modulation and can store information.

### CROSS-REFERENCE TO RELATED APPLICATIONS

This application claims priority to, and the benefit of, U.S. provisional patent application Ser. No. 63/590,166 filed on Oct. 13, 2023, incorporated herein by reference in its entirety.

### STATEMENT REGARDING FEDERALLY SPONSORED RESEARCH OR DEVELOPMENT

This invention was made with government support under Contract No. DE-AC02-05CH11231 awarded by the U.S. Department of Energy, and Grant No. HR0011-22-2-0006 awarded by the Defense Advanced Research Projects Agency. The government has certain rights in the invention.

### FUNDING ATTRIBUTION

The project leading to this application has received funding from the European Union's Horizon 2020 research and innovation programme under the Marie Sklodowska-Curie grant agreement No 895809.

### BACKGROUND

### 1. Technical Field

This technology pertains generally to low phonon energy compositions and more particularly to low phonon energy nanoparticles based on alkali lead halides that promote upconversion luminescence from higher lanthanide excited states and enable highly nonlinear, avalanche-like emission from lanthanide doped KPb₂X₅ (X═Cl, Br) nanoparticles. Methods for tuning phonon energies in the lanthanide doped potassium halide nanocrystals for enhanced non-linearity and upconversion are also provided. A practical application of the materials is illustrated.

### 2. Background

Inorganic nanocrystals embedded with lanthanide (Ln³⁺) ions can generate photostable luminescence that drives applications in near-infrared microscopy, sub-diffraction imaging, lasing, therapeutics, sensing, optogenetics, and quantum cutting. The optical performance of these doped materials is strongly influenced by the maximum phonon energy (ℏωₘₐₓ) of the nanocrystal host matrix. At moderate and high (ℏωₘₐₓ), luminescence is quenched as the Ln³⁺ excited states non-radiatively relax via phonon emission, and emission lines are modulated further via phonon-assisted energy transfer (PAET). Precise methods for tuning phonon energies can be valuable for manipulating the complex photophysical networks in Ln³⁺-based nanocrystals and for improving efficiencies of nonlinear optical processes such as upconversion, downconversion, and photon avalanching.

To generate upconverted luminescence, Ln³⁺ ions are frequently doped or alloyed into fluoride matrices such as β-NaYF₄ to leverage their low (ℏωₘₐₓ) values (300-500 cm⁻¹) relative to alternate hosts like oxides (500-600 cm⁻¹), oxysulfides (˜520 cm⁻¹), vanadates (≈890 cm⁻¹) as well as garnets (900-−1400 cm⁻¹). Low phonon energies discourage multiphonon relaxation (MPR) because MPR rates decrease exponentially as a greater number of phonons (ΔE/ℏωₘₐₓ) are needed to bridge the energy gap ΔE between adjacent Ln³⁺ states as shown in FIG. 1. However, MPR is still prevalent in fluoride nanoparticles (NPs), lowering their quantum yields and limiting their potential applications.

Host matrices based on chlorides, bromides, and iodides exhibit lower phonon energies (120-260 cm⁻¹) than corresponding fluorides, but synthesis of these halides as doped nanocrystals remains challenging. In addition, many, like LaCl₃ (ℏωₘₐₓ 250 cm⁻¹), are hygroscopic and decompose in ambient conditions, limiting their development and utility.

Bulk KPb₂Cl₅ and KPb₂Br₅ crystals are reportedly more moisture-tolerant than other halides and have band gaps (3.77 eV and 3.46 eV, respectively) that are sufficiently wide to be transparent to visible luminescence. While bulk and microscale (>200 nm) crystals of KPb₂Cl₅ have been reported, robust methods for size-controlled synthesis and doping of their NP analogues are needed, in addition to characterization of their luminescence, stability, and technological applicability.

Bistable systems can dynamically switch between two distinct states that are stable under identical external conditions. For example, bistability dictates the fate of cells during differentiation, spatial pattern formation, continual eutrophication of lakes, or snap-through responses of mechanical and magnetic switches. Distinct states of optical bistable media represent the bits used for optical logic and memory. Switching between these states with light provides the foundation of optical computing, which offers advantages over semiconductor electronics in terms of thermal dissipation and power consumption.

Intrinsic optical bistability (IOB) can occur in nonlinear materials without the need for external feedback (i.e., microring or cavity resonators), facilitating the miniaturization of components and their integration with photonic circuits. The key requirement to bistability is nonlinear positive feedback that stabilizes a higher state of the system against deactivation pathways dominant at the lower stable state. Thus, highly nonlinear nanomaterials that exhibit IOB on the nanoscale may enable the construction of very large-scale integrated optical circuits and memory.

Notably, intrinsic optical bistability has been previously studied in Ln³⁺-doped bulk crystals (e.g., Cs₃Y₂Br₉:Yb³⁺, NdPO₄:Yb³⁺), and to a lesser degree in nanoparticles. However, the bistable response of these materials was explained by thermal phenomena (e.g., thermal avalanche), underscoring the need for nanomaterials with nonthermal, all-optical IOB for fast and controllable photoswitching.

Currently, most photon avalanching materials and all lanthanide-based bistable materials driven exclusively by light require cryogenic temperatures (<160 K) for successful operation. Applications in imaging and optical/quantum computing would be more realistic if operating temperatures were closer to room temperature. Therefore, there is a need for improved processes and methods for forming materials that will address these challenges.

### BRIEF SUMMARY

Optical applications of lanthanide-doped nanoparticles require materials with low phonon energies to minimize nonradiative relaxation and promote nonlinear processes like upconversion. A new class of nanocrystals with ultra-low phonon energies is provided that will help to overcome a fundamental limitation to optical, magnetic, quantum, and electronic applications of nanomaterials capable of quenching/relaxation of excited states through interactions with phonons. Unlike many other low-phonon energy nanoparticles, these Ln³⁺-doped nanoparticles of KPb₂X₅ where (X═Cl, Br) and KPb₂(Br_{y}Cl_{1-y})₅ (where y ranges between 0 and 1) are environmentally stable, can be efficiently doped with lighter lanthanides, and have ultra-low phonon energies as low as 128 cm⁻¹ that can be tuned to balance the phonon processes that quench and assist photon upconversion in Ln³⁺ ions. These ultralow phonon energies are more than two times lower than state-of-the-art upconverting nanoparticles, exponentially reducing phonon relaxation and allowing observation of previously unseen optical phenomena, including intrinsic optical bistability and steeply nonlinear avalanche-like Nd³⁺ emission that enables deeply sub-wavelength resolution imaging (˜100 nm).

Compared with other similar lead halide materials, these particles can be synthesized with much smaller diameters and much narrower size distributions, which are required for biological imaging and nanometer-precision device manufacturing. Control over phonon energies, particularly the ability to fine tune them, will allow for more precise tailoring of the energy transfer networks within upconverting nanoparticles, allow for optimization of properties such as quantum yield, spectral/color purity, lifetime, photon avalanching threshold, and optical bistability thresholds, hysteresis widths, and coherence times.

Preferred compositions have nanoparticles with a diameter dimension in the range of about 1 nm to about 500 nm. Other preferred compositions provide nanoparticles with a diameter dimension in the range of about 8 nm to about 155 nm or within the range of about 40 nm to about 55 nm. The nanoparticles preferably have an actual lanthanide dopant concentration of between about 0 mol. % and about 100 mol %. In other embodiments, the concentration lanthanide dopant is within the range of about 0.4 mol % to about 4.1 mol %. The lanthanide dopants are preferably selected from the group of La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, Lu³⁺, and combinations thereof.

Also presented are methods for the size-controlled synthesis of low-phonon-energy KPb₂X₅ (X═Cl, Br) nanoparticles and the ability to tune nanocrystal phonon energies. The produced KPb₂Cl₅ nanoparticles are moisture resistant and can be efficiently doped with lighter lanthanides. The low phonon energies of KPb₂X₅ nanoparticles promote upconversion luminescence from higher lanthanide excited states and enable highly nonlinear, avalanche-like emission from KPb₂Cl₅:Nd³⁺ nanoparticles.

The invention works by first synthesizing alkaline metal halide nanoparticles. To do so, an approach was devised where myristoyl halide precursors were rapidly injected into 100° C. to 310° C. solutions of lead acetate, potassium carbonate, oleylamine, oleic acid, and octadecene. By selecting myristoyl halides as precursors due to their high boiling points (˜250° C.), the synthesis reaction was possible at higher temperatures promoting crystallinity (pure monoclinic phase of all nanocrystals) and size control (variable in 9 nm to 160 nm range) of low-phonon energy alkaline metal halide nanoparticles. These novel nanocrystals are stable at ambient and high relative humidity conditions and exhibit doubly reduced phonon energies as compared to the state-of-the-art fluoride-based analogous nanoparticles.

To determine whether these alkaline metal halide nanoparticles can host lanthanide ions and facilitate upconversion luminescence we introduced various lanthanide ions in the reaction mixture. The lanthanide doped potassium lead halide nanoparticles demonstrated luminescence of visible photons under near infrared laser excitation, including new luminescence bands from higher lanthanide excited states (e.g. those of erbium), that are only possible to see in the low-phonon energy host matrices, as developed herein.

Initial exploratory studies also indicated an important technical issue related to the doping efficiency of these alkaline metal halide nanoparticles. It was noticed that light-lanthanide doping (e.g. with neodymium ions) is more efficient than heavy-lanthanide doping (e.g. erbium, thulium, ytterbium ions). In the latter case only up to 3.5% of total erbium+ytterbium content was found in most nanoparticles, which limits their optical applications due to insufficient brightness.

This hurdle was overcome with light-lanthanide doping, which proved to be more efficient and controllable. When doped with neodymium ions, the low phonon energy of potassium lead chloride nanoparticles allowed the observation of highly nonlinear upconversion emissions at visible and near infrared wavelengths under a 1064 nm excitation at room temperature. Subsequent studies resulted in the extreme enhancement of nonlinearity of photon by cooling these nanoparticles below 160 K temperatures, at which point the intrinsic optical bistability and optical hysteresis was discovered. As used herein, the term optical bistability means that the nanoparticles can emit at 2 distinct levels of emission power (apart from being off) even though the input excitation power is varied over a smooth range. In essence, the particles are “digital” with 0 and 1 levels, rather than being analog, thus lending themselves as bits for optical computing.

Intrinsic optical bistability (IOB) could provide bit-level functionality to allow all-optical computing, yet limited understanding and control of IOB in luminescent materials limits their utility. Here, the IOB of Nd³⁺-doped nanocrystals, which are either bright or dark at the same excitation power based on power history are used to illustrate the materials. It has been shown that high-contrast switching and IOB are enabled via the photon avalanche process, which sustains population inversion between the ground and the first excited 4f^{N} states of Nd³⁺ ions. This phenomenon is due to the low-phonon-energy KPb₂Cl₅ host and efficient cross-relaxation between Nd³⁺ dopants, which counteract quenching. The IOB of these nanocrystals can be controlled by temporal pump modulation and can store information. The ability to induce and manipulate all-optical bistabilities in nanocrystals establishes the foundation for nanoscale optical memory and logic.

The preferred IOB materials are illustrated with lanthanide (Ln³⁺)-doped, avalanching nanoparticles (ANPs), which are the most nonlinear nanomaterials with a reported luminescence power-scaling equivalent to >30-photon process. Compared to other frequency-converting nanomaterials (multi-harmonic nanoparticles, quantum dots), ANPs show near-digital luminescence switching at low pump powers (kW·cm⁻² vs. MW·cm⁻²), which is promising for high-speed, power-efficient data handling.

Accordingly, the production of nanoparticles with tunable, ultra-low phonon energies facilitates the discovery of nanomaterials with phonon-dependent properties, precisely engineered for applications in nanoscale imaging, sensing, luminescence thermometry and energy conversion.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a depiction of a monoclinic KPb₂Cl₅ lattice and the impact of its low phonon energy (ℏωₘₐₓ) on the multi-phonon relaxation (wavy arrows) of Ln³⁺ excited states (E1/E2, populations represented by numbers of circles).

FIG. 2 is a plot of XRD patterns of KPb₂Cl₅, KPb₂(Br_{0.375}Cl_{0.625})₅, and KPb₂Br₅ NPs synthesized with 6:1 OA/OM.

FIG. 3 is a TEM image of KPb₂Cl₅ NPs synthesized by tuning OA/OM with an OA:OM ratio of 1:1.

FIG. 4 is a TEM image of KPb₂Cl₅ NPs synthesized by tuning OA/OM with an OA:OM ratio of 1.35:1.

FIG. 5 is a TEM image of KPb₂Cl₅ NPs synthesized by tuning OA/OM with an OA:OM ratio of 2:1.

FIG. 6 is a TEM image of KPb₂Cl₅ NPs synthesized with 6:1 OA/OM. Scale bars in C—H are 50 nm.

FIG. 7 is a TEM of KPb₂(Br_{0.375}Cl_{0.625})₅, NPs synthesized with 6:1 OA/OM.

FIG. 8 is a TEM image of KPb₂Br₅ NPs synthesized with 6:1 OA/OM.

FIG. 9 is a plot of diameter vs reaction temperature for KPb₂Cl₅ NPs synthesized with 6:1 OA/OM. Error bars represent ±1 standard deviation in size distribution.

FIG. 10 is a plot of diameter vs OA/OM at 240° C. Error bars represent ±1 standard deviation in size distribution.

FIG. 11 is a plot of Raman spectra of undoped KPb₂Cl₅, KPb₂(Br_{0.375}Cl_{0.625})₅, KPb₂Br₅, and NaYF₄ NPs.

FIG. 12 is a plot of upconverted emission spectra of Yb³⁺, Er³⁺-codoped KPb₂X₅ and NaYF₄ NPs under 980 nm excitation (101 W/cm²). Peaks are labeled by radiative state.

FIG. 13 is a plot of stability of KPb₂Cl₅:Yb³⁺, Er³⁺ NPs exposed to 65% RH over 12 weeks, measured by XRD.

FIG. 14 is a plot of stability of KPb₂Cl₅:Yb³⁺, Er³⁺ NPs exposed to 100% RH over 12 hours, investigated with in situ upconverted luminescence. Insets show temporal evolution of upconversion intensity. The XRD patterns indicate exposure times shown in the inset. Spectra measured under 980 nm excitation (57 W/cm²).

FIG. 15 is a plot of actual versus nominal [Nd³⁺] incorporation in KPb₂Cl₅:Nd³⁺ NPs, measured by ICP-OES.

FIG. 16 is a plot of upconverted (left) and downshifted (right) luminescence spectra of KPb₂Cl₅:0.4% Nd³⁺ NPs under 800 nm (14 W/cm²) excitation. Inset: ⁴F_{3/2} excited state lifetimes vs nominal [Nd³⁺].

FIG. 17A is a plot of visible and NIR upconversion spectrum of KPb₂Cl₅:16% Nd³⁺ NPs under 1064 nm excitation (34 kW/cm²).

FIG. 17B is a plot of emission intensity vs excitation power of the most intense Nd³⁺ upconversion bands, showing steeply nonlinear upconversion. Dashed lines are linear fits at maximum slope s for each curve.

FIG. 18 depicts TEM images of different KPb₂Cl₅ NPs synthesized by tuning the OA/OM ligand ratio.

FIG. 19 is a plot of corresponding size distributions of the NPs, as well as their normal fits, of the different KPb₂Cl₅ NPs synthesized by tuning the OA/OM ligand ratio of the NPs of FIG. 18.

FIG. 20 depicts TEM images of different KPb₂Cl₅ NPs synthesized by tuning the reaction temperature.

FIG. 21 is a plot of corresponding size distributions of the NPs, as well as their normal fits, of the different KPb₂Cl₅ NPs of FIG. 20 synthesized by tuning the synthesis reaction temperatures.

FIG. 22 is a schematic diagram illustrating Intrinsic optical bistability in KPb₂Cl₅:Nd³⁺ ANPs. Bistable ANPs switch from dark to bright, stable state at an increased 1064 nm pump power, which persists even when the power is decreased.

FIG. 23 is a plot illustrating the luminescence hysteresis that is a hallmark of IOB in bistable ANPs.

FIG. 24 is a diagram visualizing how laser power (Pₓ) shapes the landscape of states of ANPs, moving from a dark to a bright state through an instability region. Quenching by multiphonon relaxation (MPR) dominates a dark state, while the positive feedback loop of excited state absorption (ESA) and cross-relaxation (CR) stabilizes a bright state.

FIG. 25 is a plot of power density versus intensity illustrating the pump power dependence of Nd³⁺ emission (810 nm, ⁴F_{5/2}→⁴I_{9/2}) in KPb₂Cl₅:Nd³⁺ ANPs at 77 K. The data points 1 to 2 represent scanning with increasing powers (up scan), and the data points 3 with decreasing (down scan). Optical hysteresis can be evidenced in the down scan direction.

FIG. 26 is a plot of luminescence spectra of KPb₂Cl₅:Nd³⁺ nanocrystals corresponding to power and up scan and down scan as illustrated in FIG. 25.

FIG. 27 is a plot of intensity versus power density at different temperatures illustrating the pump power dependence of Nd³⁺ emission (810 nm, ⁴F_{5/2}→⁴I_{9/2}) in KPb₂Cl₅:Nd³⁺ ANPs in the 110-170 K temperature range.

FIG. 28 is a plot of Pump power dependence of Nd³⁺ ground (⁴I_{9/2},) and first excited state (⁴I_{11/2,}) population ratio in a simulated KPb₂Cl₅:20 mol % Nd³⁺ system. The dashed line corresponds to power up and solid to power down scans.

FIG. 29 is a simplified Nd³⁺ energy level diagram showing GSA, cross-relaxations (CR #), ESA, and emission. ESA and CR1 form a positive feedback loop, leading to giant signal amplification and IOB. Competing MPR (wavy arrow) is also shown.

FIG. 30 is a plot showing the influence of cross-relaxation pathway knock-outs on the hysteresis width and nonlinearity for ⁴F_{3/2}→⁴I_{9/2} radiative transition. WT—wild type, CR #, as shown in FIG. 29.

FIG. 31 is a plot illustrating the pump power dependence of Nd³⁺ emission in KPb₂Cl₅:Nd³⁺ ANPs at 77 K under 1064 nm continuous wave (CW) and pulsed pump excitation (40% duty cycle).

FIG. 32 is a plot showing hysteresis width with pulsing frequency.

FIG. 33 is a plot of PA switch-on threshold vs. pump pulse frequency (40% duty cycle). Corresponding dependence on the temporal separation between pulses is also shown. Respective values under the CW pump are shown as squares.

FIG. 34 is a plot of signal intensity versus bias power density illustrating the pump power dependence of KPb₂Cl₅:Nd³⁺ nanocrystals used for photoswitching experiments with a gray circle indicating the power density of applied 1064 nm bias. The bistability region and instability crossing after the GSA pulse (gray arrow) are shown.

FIG. 35 is graph of time recording of emission at 880 nm of KPb₂Cl₅:Nd³⁺ nanocrystals before and after brief exposure to 808 nm control input.

### DETAILED DESCRIPTION

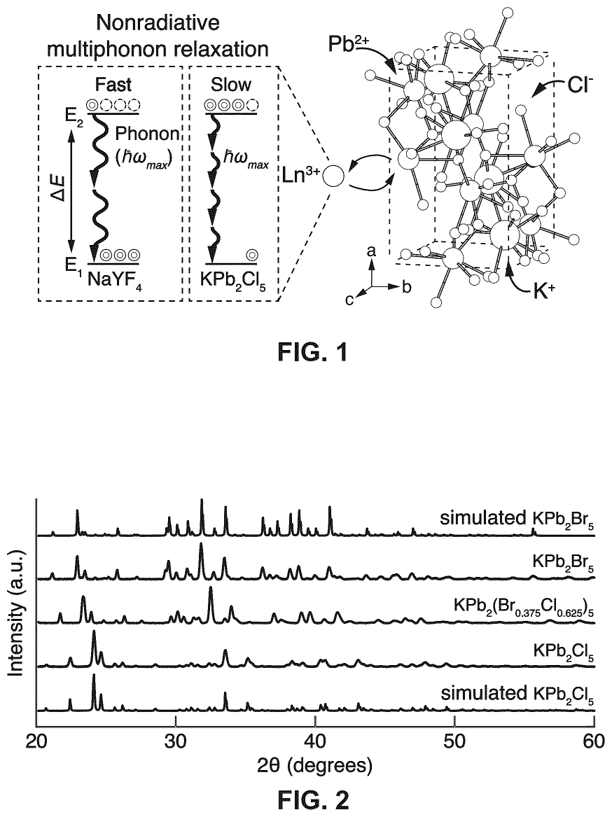

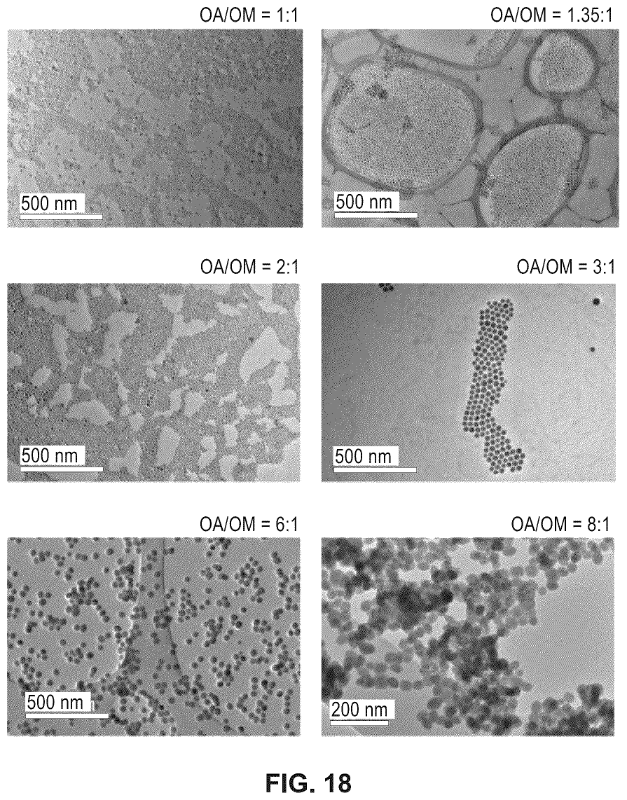

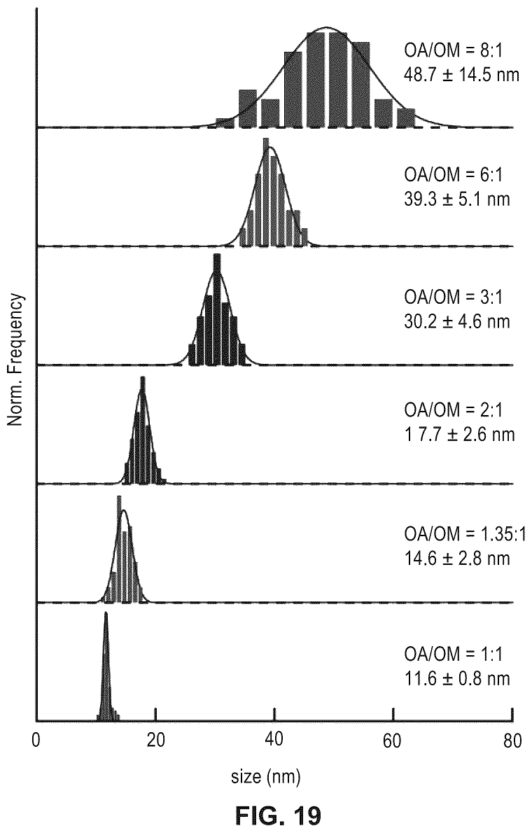

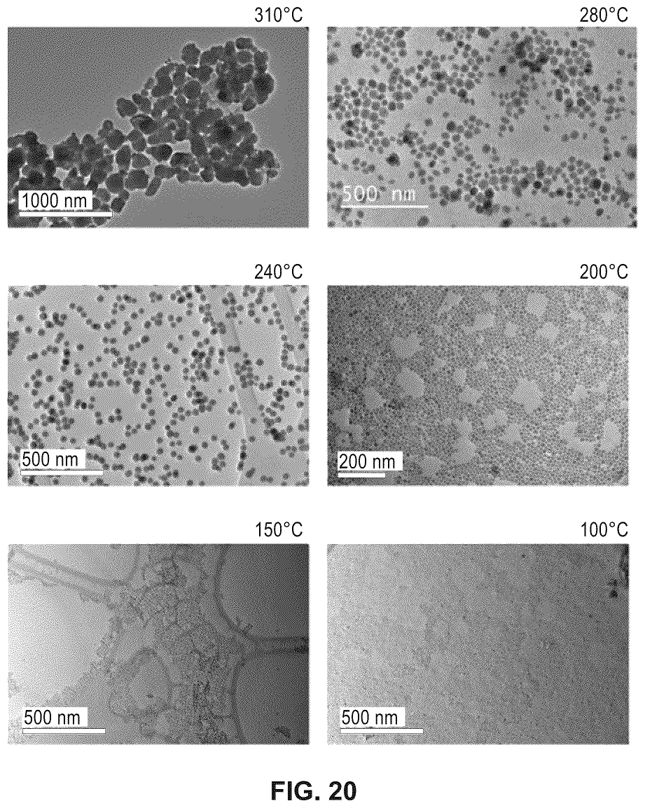

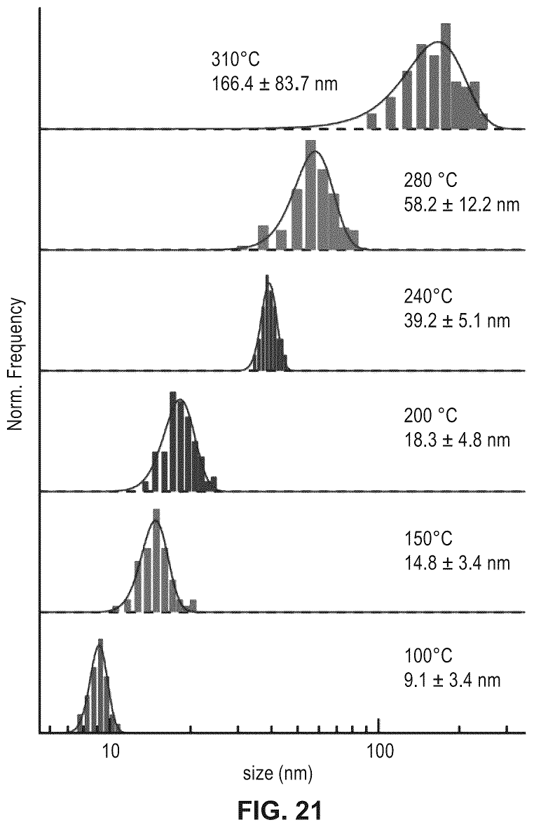

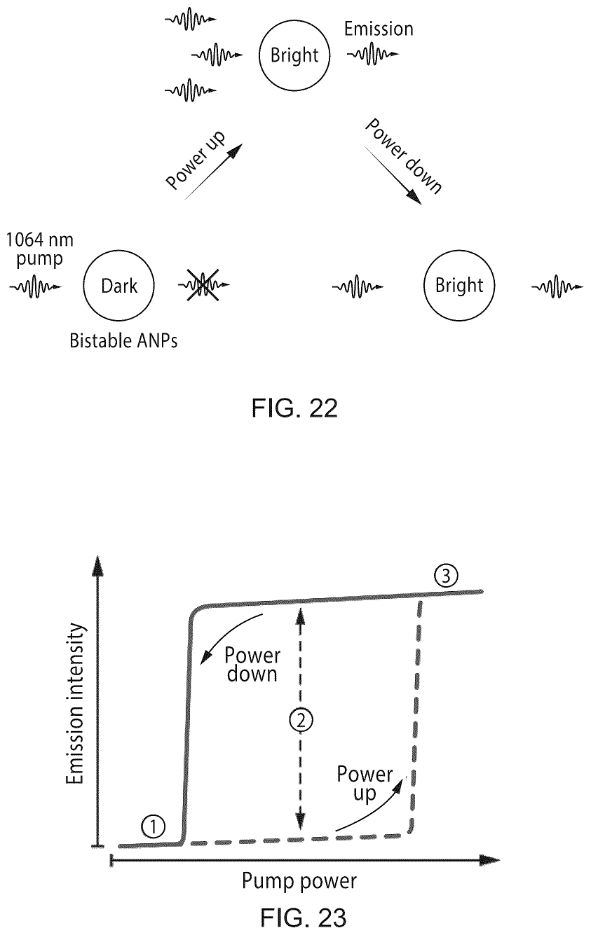

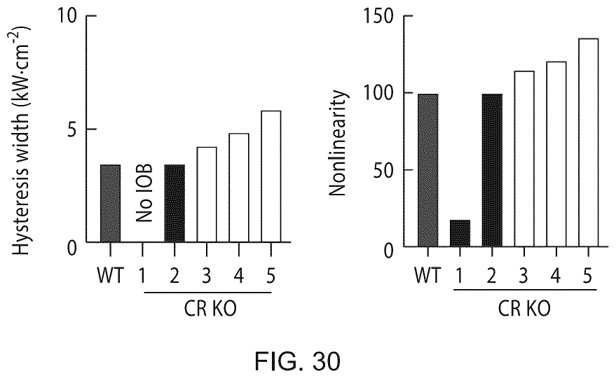

Referring more specifically to the drawings, for illustrative purposes, a new class of nanocrystal compositions with ultra-low phonon energies and systems and methods of size-controlled synthesis and doping and methods of use are generally shown. Several embodiments of the technology are described generally in FIG. 1 to FIG. 35 to illustrate the characteristics and functionality of the compositions, systems, materials and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

In general terms, the technology described in this disclosure are low phonon energy compositions and applied methods for size-controlled synthesis and doping of the nanoparticle compositions and methods of use. Although specific compositions are used to illustrate the system and methods, other structures and adaptations can be used to achieve the desired functionality of tunable phonon energies at near room temperatures.

Turning now to FIG. 1 to FIG. 10, one embodiment of a method for colloidal synthesis of Ln³⁺-doped nanocrystals with ultra-low phonon energies using KPb₂X₅ (X═Cl, Br) host matrices is set forth and the luminescence and environmental stability of the produced particles is described. It can be seen in FIG. 1 that the KPb₂X₅ NP phonon energies can be tuned readily through the alloying of their halide ions, and that these perovskite-like nanomaterials are stable under high humidity. The ultra-low ℏωₘₐₓ of these NPs also promotes upconversion luminescence from Ln³⁺ excited states typically quenched in conventional matrices with higher ℏωₘₐₓ and gives rise to steeply nonlinear luminescence in Nd³⁺-doped KPb₂Cl₅.

To synthesize KPb₂X₅ NPs, myristoyl halide precursors are rapidly injected into 100° C. to 310° C. solutions of Pb(OAc)₄, K₂CO₃, oleylamine (OM), oleic acid (OA), and octadecene (ODE). Acyl halides react readily with nucleophiles such as OM and oleate ions to release hydrohalic acids (HX) that can react with metal precursors to nucleate and grow KPb₂X₅ NPs. Myristoyl halides were selected as precursors due to their high boiling points (˜250° C.), which allowed for higher reaction temperatures that promote crystallinity and size control of NPs via temporally distinct nucleation.

High-resolution transmission electron microscopy (HRTEM) of the different KPb₂Cl₅ NPs showed 2.70 Å lattice spacings corresponding to the (311) crystal plane of monoclinic KPb₂Cl₅ with P21/c space group, matching measured with reference (PDF #01-073-4316) powder X-ray diffraction (XRD) patterns as shown in FIG. 2.

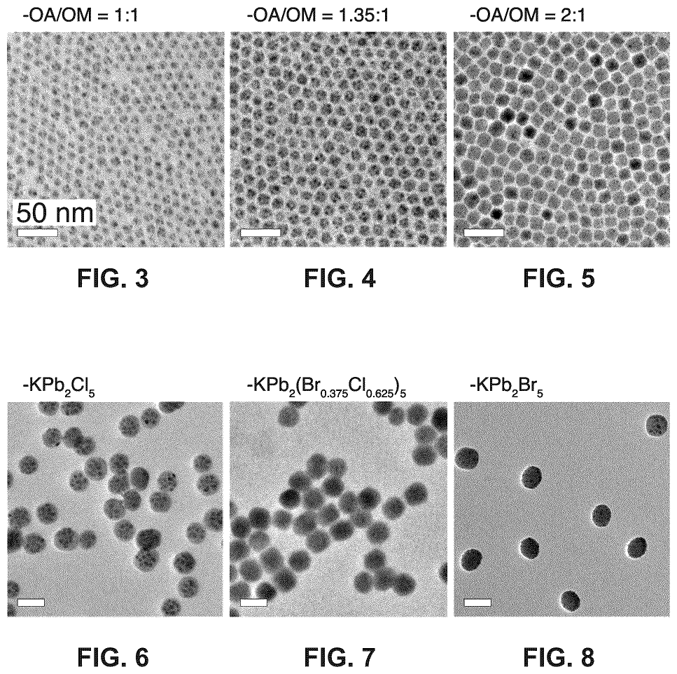

Reaction temperature and OA/OM ratio can each be varied to tune NP size while maintaining reasonable polydispersity as seen in the micrographs of FIG. 3 through FIG. 8. The TEM images shown in FIG. 3, FIG. 4 and FIG. 5 show KPb₂Cl₅ NPs synthesized by tuning OA/OM. The TEM of FIG. 6, FIG. 7 and FIG. 8 show KPb₂Cl₅, KPb₂(Br_{0.375}Cl_{0.625})₅, and KPb₂Br₅ NPs synthesized with 6:1 OA/OM. Scale bars in C—H are 50 nm.

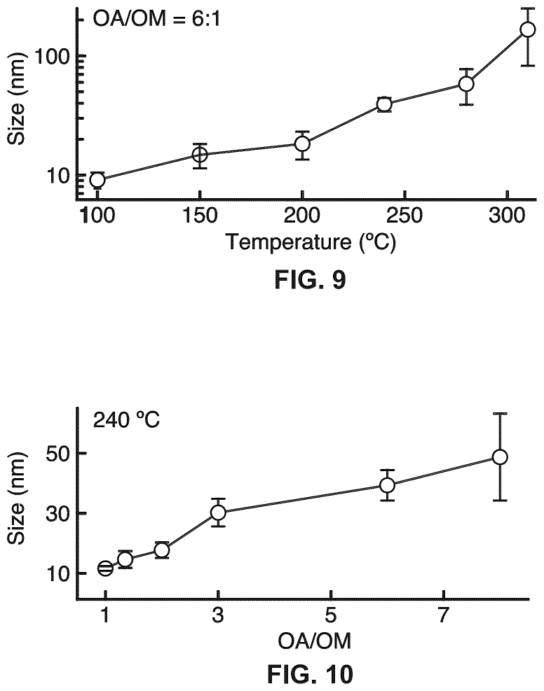

Varying the reaction temperature from 100° C. to 310° C. produces KPb₂Cl₅ NPs with diameters ranging from about 8.9 nm to about 155 nm at 6:1 OA/OM as shown in the graph of FIG. 9. Meanwhile, varying OA/OM from 1:1 to 8:1 fine-tunes diameters from about 11.9 nm to about 49.7 nm (240° C.) as shown in FIG. 10.

The NP size distributions ranged from 7% to 50%, with the narrowest distributions at low OA/OM and temperature. Increasing OA/OM may increase size and polydispersity by promoting protonation of OM by OA and their condensation into N-oleyloleamide. These reactions can deactivate OM as a nucleophile for acyl halide decomposition, suppressing nucleation. The OA may also increase NP size by increasing the solubility of metal salts, decreasing nucleation and nuclei growth rates while promoting Ostwald ripening.

To determine if this synthetic scheme could produce metal halide nanocrystals with even lower and more tunable phonon energies, appropriate ratios of chloride and bromide precursors were combined to synthesize KPb₂Br₅, and mixed-halide KPb₂(BrₓCl₁₋ₓ)₅ NPs as illustrated in the TEM images of FIG. 6 to FIG. 8.

Under the same reaction conditions (240° C. and 6:1 OA/OM), KPb₂Cl₅, KPb₂(Br_{0.375}Cl_{0.625})₅, and KPb₂Br₅ NP materials were synthesized with similar sizes of approximately 40 nm in diameter. The acquired XRD patterns in FIG. 2 of KPb₂Cl₅, KPb₂(Br_{0.375}Cl_{0.625})₅, and KPb₂Br₅ NPs showed pure monoclinic phases. The single peak of KPb₂(Br_{0.375}Cl_{0.625}) (2θ=23.39°) is positioned between the peaks of pure KPb₂Cl₅) (24.14°) and KPb₂Br₅ (22.94°), corroborating the 5:3 Br:Cl atomic ratio measured by energy-dispersive X-ray spectroscopy (EDS) and confirmed their successful alloying.

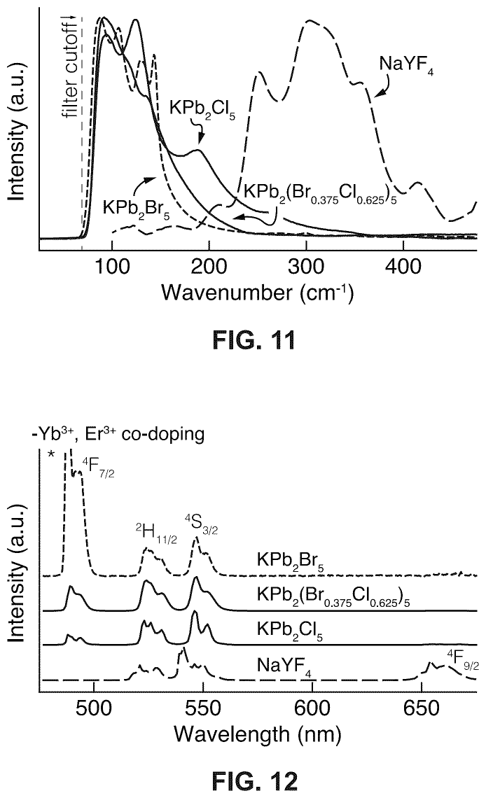

As depicted in FIG. 11, the amplitude-averaged phonon energies (ℏω_{avg}) that were extracted from Raman spectra were 152 cm⁻¹, 136 cm⁻¹, and 128 cm⁻¹ for undoped KPb₂Cl₅, KPb₂(Br_{0.375}Cl_{0.625})₅ and KPb₂Br₅ NPs, respectively. These phonon energies are consistent with those measured and simulated for bulk crystals and decrease with the increasing mass of the halide ion. Notably, KPb₂Cl₅ nanocrystal phonon energies are 2-fold smaller than the ℏω_{avg}≈309 cm⁻¹ of β-NaYF₄ NPs most commonly used in Ln³⁺-based upconversion.

Whether KPb₂X₅ nanocrystals could host Ln³⁺ ions, and how lower phonon energies influence their luminescence, by incorporating Yb³⁺ and Er³⁺ into reaction solutions was also investigated. To confirm doping, elemental compositions of the resulting NPs were measured using EDS, X-ray photoelectron spectroscopy and inductively coupled plasma optical emission spectroscopy (ICP-OES, See Table 1 and Table 2).

Upconversion luminescence spectra of dried KPb₂X₅:Yb³⁺, Er³⁺ NPs were measured at ambient conditions under 980 nm excitation and examined for differences with canonical NaYF₄:Yb³⁺, Er³⁺ UCNPs. Compared to their NaYF₄ counterparts, the KPb₂Cl₅:2.9% Yb³⁺, 0.6% Er³⁺ NPs show significantly stronger 525 nm emission (Er³⁺:²H_{11/2}→⁴I_{15/2}) with respect to their 545 nm (⁴S_{3/2}→⁴I_{15/2}) bands, approaching a 1:1 ratio. The NaYF₄, the Er³⁺:²H_{11/2} and ⁴S_{3/2} manifolds are assumed to be thermally equilibrated since the small, ˜700 cm⁻¹ energy gap between them is readily bridged by 2 phonons. The enhanced population of the ²H_{11/2} level in KPb₂Cl₅, suggests a dramatic reduction in MPR rate owing to the 2-fold lower ho avg. The NPs also exhibit significantly diminished 660 nm emission (Er³⁺:⁴F_{9/2}→⁴I_{15/2}) relative to green emission peaks and a prominent emission band around 490 nm (⁴F_{7/2}→⁴I_{15/2}) as shown in FIG. 12. This 490 nm band is typically absent in NaYF₄:Yb³⁺, Er³⁺ UCNPs and its intensity is enhanced as ℏω_{avg} of the host decreases [compare KPb₂(Br_{0.375}Cl_{0.625})₅ and KPb₂Br₅, providing additional evidence for reduced MPR.

To understand the origins of these spectral differences, rate equation models were used to show that 660 nm emission from KPb₂Cl₅:Yb³⁺, Er³⁺ is suppressed due to reduced rates of phonon-assisted transitions that populate the ⁴F_{9/2} manifold, e.g., MPR from the Er³⁺:⁴S_{3/2} manifold and cross-relaxation (CR) involving the MPR-populated Er³⁺:⁴I_{13/2} manifold. In contrast, emission at 490 nm and 525 nm was enhanced due to reduced MPR from corresponding Er³⁺:⁴F_{7/2} and ²H_{11/2} radiative states.

It was noted that KPb₂X₅ NPs were not necessarily brighter and often appeared dimmer than their NaYF₄ analogues, which could be due in part to the role of MPR and PAET populating states critical to luminescence pathways. Nevertheless, the ability to manipulate MPR and PAET rates by tuning host phonon energies provides a method to modulate luminescence from Ln³⁺-doped NPs and promote emission from excited states normally quenched by MPR, as shown in unconventional upconversion and downshifting spectra of the KPb₂Cl₅ NPs doped with Ho³⁺, Pr³⁺, Nd³⁺, Dy³⁺, and Tm³⁺ dopants.

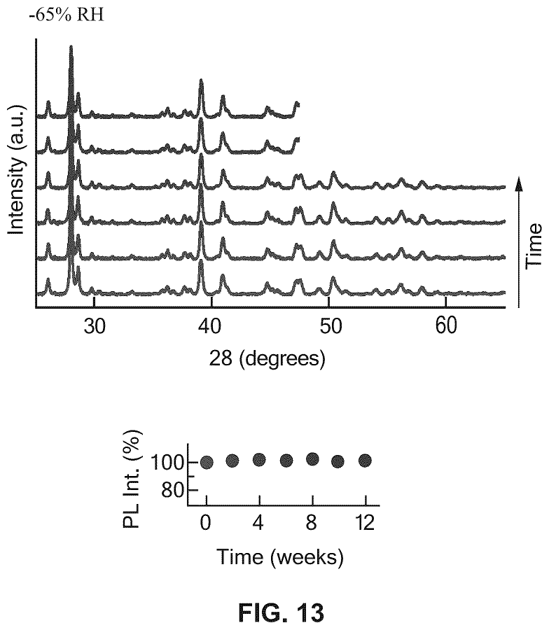

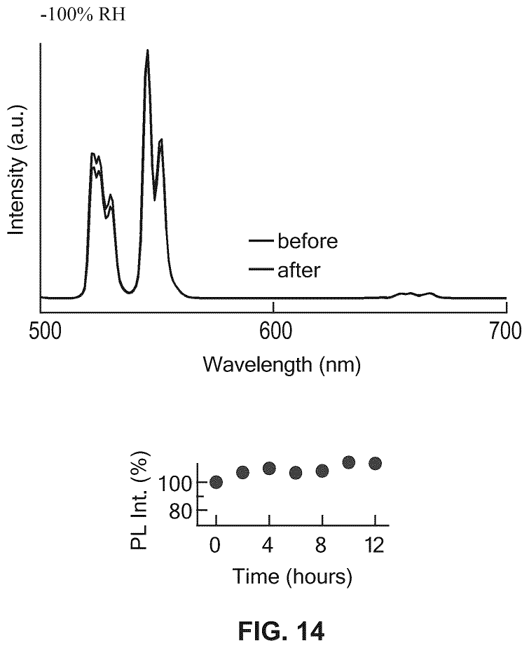

The chemical-and photo-stability of the KPb₂Cl₅:Yb³⁺, Er³⁺ NPs under ambient conditions at relative humidities (RH) of 65% and 100% were considered to evaluate the hygroscopicity and instability of other low-phonon-energy materials. Films of KPb₂Cl₅ NPs were found to be chemically stable over the course of three months under 65% RH, as demonstrated by the invariance of XRD patterns and upconversion emission intensity shown in FIG. 13. Even at 100% RH, emission spectra seen in FIG. 14 and associated XRD patterns did not show notable changes after 5 days. KPb₂Cl₅:Yb³⁺, Er³⁺ NPs are also photostable under continuous 980 nm laser irradiation (35 W/cm²) for 15 hours and show no significant heating, similar to NaYF₄ UCNPs. However, immersing powder samples in water causes decomposition of KPb₂Cl₅ NPs, indicating that additional surface passivation is necessary for aqueous applications.

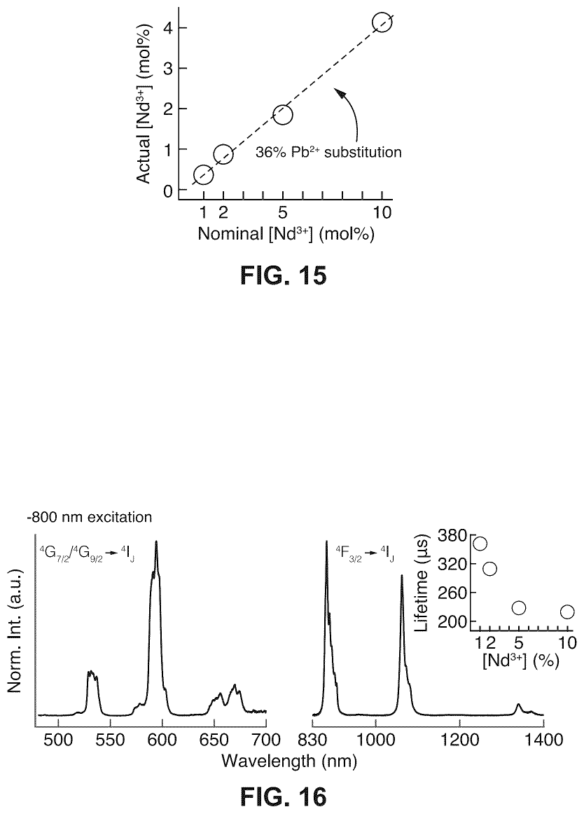

The ICP-OES of Er³⁺/Yb³⁺ doping into KPb₂X₅ NPs reveals that these heavy Ln³⁺ ions are not efficiently incorporated, regardless of reaction stoichiometry (Table 1 and Table 2), likely due to differences in charge and ionic radii between Ln³⁺ and Pb²⁺ ions. Because the larger radii of lighter Ln³⁺ ions have smaller mismatch with the Pb²⁺-based matrix, we doped KPb₂Cl₅ NPs with Nd³⁺ ions, commonly used to sensitize 800 nm excitation. ICP-OES shows that KPb₂Cl₅ NPs can be doped with Nd³⁺ ions, with the actual Nd³⁺ composition measured to be 36% of nominal inputs (FIG. 15, Table 3).

Under 800 nm excitation at ambient conditions, KPb₂Cl₅:0.4% Nd³⁺ NPs demonstrate downshifted NIR emission (883, 1062, 1340 nm) and visible upconversion to 533 nm, 595 nm, and 660 nm (FIG. 16), which is notable since upconversion in Nd³⁺-codoped NaYF₄ has only been observed at >10⁶ W/cm² excitation in single UCNPs. The ability to control Nd³⁺ doping in KPb₂Cl₅ was also confirmed by the monotonic decrease of the ⁴F_{3/2} excited-state lifetime (FIG. 16); this quenching is associated with CR between Nd³⁺ ions at high concentrations. The ⁴F_{3/2} lifetime in KPb₂Cl₅:4.1% Nd³⁺ NPs (220 μs) is greater than that of core/shell NaGdF₄:5% Nd³⁺@NaGdF₄ NPs (136 μs) and is the result of reduced MPR in the KPb₂Cl₅.

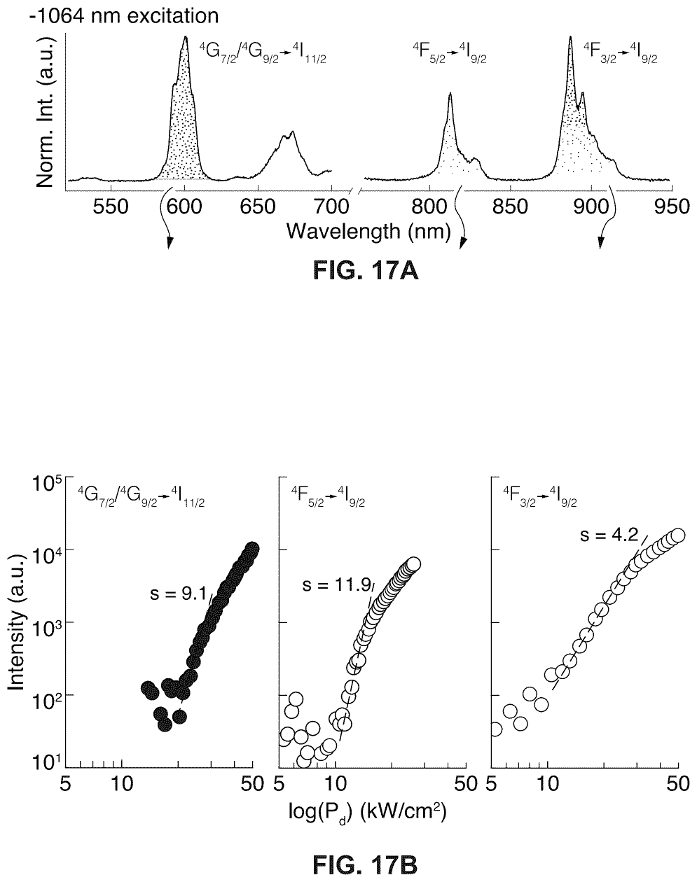

The low phonon energy of KPb₂Cl₅ allows the observation of highly nonlinear upconversion emission at visible and NIR wavelengths from heavily doped KPb₂Cl₅:16% Nd³⁺ NPs excited at 1064 nm at room temperature (FIG. 17A). As the excitation power density (P) is increased above a threshold of approximately 10 kW/cm², the luminescence intensities (I) of major emission lines increase nonlinearly (FIG. 17B) with power dependence s reaching 9 and 12, at 595 nm and 810 nm, respectively (where I∝P^{s}). We ascribe this steep power dependence to an energy looping mechanism that nonlinearly amplifies Nd³⁺ excited state populations through repeated cycles of excited state absorption (ESA) and CR, without thermal assistance. Energy looping and its extreme form, photon avalanching (PA), have been predicted in NaYF₄:Nd³⁺ NPs but not observed experimentally. PA-like behavior has been observed in NdAl₃(BO3)₄ but only under extreme heating. The low phonon energy of KPb₂Cl₅ promotes nonlinearity by ensuring that nonresonant ground state absorption in Nd³⁺ is much slower than resonant ESA, a key characteristic of PA. KPb₂Cl₅:16% Nd³⁺ NPs meet several other (but not all) criteria for PA, including threshold-like behavior (FIG. 17B) and luminescence rise times that lengthen significantly, to approximately 70 ms, near avalanching thresholds. The steep nonlinearities of these Nd³⁺-doped, low-phonon-energy NPs suggest that they may be useful as probes for sub-diffraction confocal imaging since the nonlinear Abbe resolution δ=λ/(2 NA \sqrt{s}) is 100 nm for s=12 at 1064 nm pump wavelength (λ) and 1.4 numerical aperture (NA).

In sum, the size-controlled synthesis of low-phonon-energy, Ln³⁺-doped KPb₂X₅ NPs was stable towards humidity. The ultra-low phonon energies of these materials (ℏω_{avg}=120-160 cm⁻¹) enabled discovery of highly nonlinear, avalanche-like Nd³⁺ emission and Ln³⁺ emission lines not observed in fluoride UCNPs, facilitating multicolor widefield and sub-diffraction imaging. Finally, intensities of low-phonon-energy NPs suggest that Ln³⁺ luminescence is maximized not at the lowest phonon energies, but at phonon energies that simultaneously minimize deleterious MPR while maintaining critical phonon-assisted pathways. The mixed-halide alloying approach demonstrated here will facilitate such optimization and will be valuable for manipulating complex photophysical networks in Ln³⁺-based nanomaterials and other phonon-dependent systems. Future developments of heterostructured low-phonon-energy UCNPs, and their translation to aqueous colloids, will facilitate applications from nanophotonics to biomedicine.

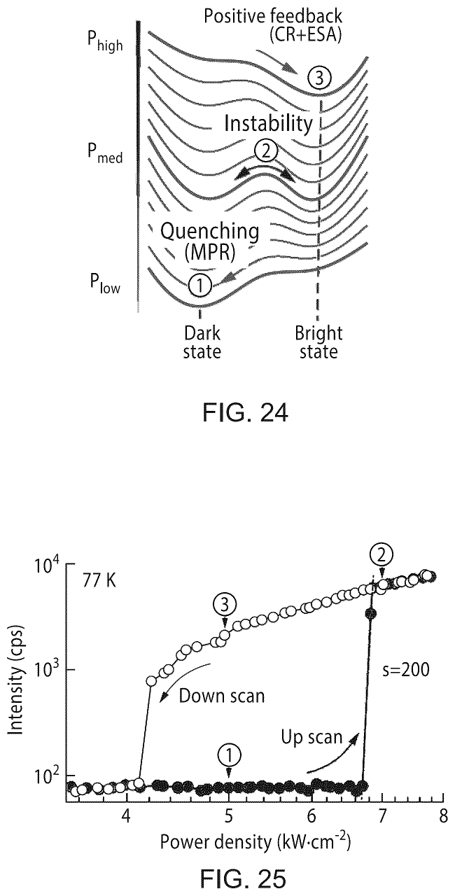

An illustration of one application of the nonthermal IOB materials is demonstrated with KPb₂Cl₅:Nd³⁺ ANPs as a result of their highly nonlinear response, equivalent to >200-photon process. When cooled, these low-phonon-energy ANPs exhibit two luminescent states: a dark, poorly emissive state and a bright state that emits upconverted luminescence as shown in FIG. 23. Both of these states are dependent on the power history of excitation at 1064 nm, for example, as seen in FIG. 24. With increasing pump power, switching from a dark to a bright state is done via photon avalanche (PA) process, which acts as positive feedback to maintain the bright state as illustrated in FIG. 25. Finally, control over the IOB is demonstrated via temporal laser modulation and optical memory with bistable KPb₂Cl₅:Nd³⁺ ANPs. The possibility to induce, control, and utilize IOB in KPb₂Cl₅:Nd³⁺ ANPs will accelerate the development of optical computers and photonic neural networks.

The technology described herein may be better understood with reference to the accompanying examples, which are intended for purposes of illustration only and should not be construed as in any sense limiting the scope of the technology described herein as defined in the claims appended hereto.

### EXAMPLE 1

In order to demonstrate the synthesis and characteristics of produced nanocrystals, undoped KPb₂Cl₅ nanoparticles were produced and evaluated. KPb₂Cl₅ nanoparticles (NPs) were synthesized by a colloidal chemical hot injection method. Lead acetate trihydrate (Pb(CH₃COO)₂·3H₂O, 99.99%) was purchased from Alfa Aesar, Potassium carbonate, anhydrous (K₂CO₃, 99%), neodymium (III) acetate hydrate (Nd(CH₃COO)₃·xH₂O, 99.9%), ytterbium (III) acetate hydrate (Yb(CH₃COO)₃·xH₂O, 99.9%), erbium (III) acetate hydrate (Er(CH₃COO)₃·xH₂O, 99.9%), thulium (III) acetate hydrate (Tm(CH₃COO)₃·xH₂O, 99.9%), terbium (III) acetate hydrate (Tb(CH₃COO)₃·xH₂O, 99.9%), holmium (III) acetate hydrate (Ho(CH₃COO)₃·xH₂O, 99.9%), praseodymium (III) acetate hydrate (Pr(CH₃COO)₃, 99.9%), erbium (III) chloride (ErCl₃, 99.9+%), ytterbium (III) chloride (YbCl₃, 99.9+%), yttrium (III) chloride (YCl₃, 99.9+%), sodium iodide (NaI, 99.99%), ammonium fluoride (NH₄F, 99.9%), benzoyl bromide (C₆H₅COBr, 97%), myristoyl chloride (99%), benzoyl chloride (C₆H₅COCl, 98%), oleic acid (OA, 90%), oleylamine (OM, 70%), octadecene (ODE, technical grade, 90%), and hexane (anhydrous, 99.5%) were purchased from Sigma-Aldrich. Sodium oleate (>97%) was purchased from TCI. All chemicals were used without any further purification.

In a typical synthesis, potassium carbonate (6.9 mg), lead acetate trihydrate (76 mg), 3 mL of OA, 0.5 mL of OM, and 6 mL of ODE were added into a 50 mL 3-neck round bottom flask. The solution was stirred and degassed under vacuum on a Schlenk line at 40° C. for 5 min and then degassed at 120° C. for 1 hour to remove volatile solvents and water. Subsequently, the temperature was increased to a growth temperature of 240° C. under nitrogen. Upon reaching the reaction temperature, 0.3 mL of myristoyl chloride was swiftly injected. The color of the solution suddenly changed from transparent to cloudy white, indicating an instantaneous nucleation and growth of KPb₂Cl₅ NPs. Thereafter, the reaction flask was immediately immersed in an ice-water bath and the sample was separated by centrifugation at 3000 rpm for 5 min. The supernatant was discarded, and the precipitate was redispersed in 5 mL of hexane for further use.

### EXAMPLE 2

To further evaluate and characterize the quality of synthesis schemes, undoped KPb₂Cl₅ nanoparticles with various sizes were synthesized for evaluation. The synthesis followed the above protocol, except changing the reaction temperature and the concentration of the ligands. When the temperature was fixed at 240° C., the ratio between OM and OA was changed from 1:6, 1:3, 1:2, 1:1.35 and 1:1 to get the nanoparticles with the size and size distributions shown in FIG. 6. When the ratio between OM and OA was fixed at 1:6, the synthesis temperatures were varied from 100, 150, 200, 240, 280 to 310° C. to produce the nanoparticles with the size and size distributions shown in FIG. 7.

The role of OA, OM, and temperature in the size control of KPb₂X₅ NPs was rationalized in the following ways. 1) The acid-base equilibrium plays an important role in the synthesis of KPb₂X₅ NPs. The acyl halides will be decomposed in the presence of OA and OM. OA reacts with OM by donating its proton, forming a primary ammonium salt, as confirmed by previous reports. From nuclear magnetic resonance measurements, an equilibrium constant of about 2·10² was estimated, which is significantly lower than the expected approximate 10⁶ value in an aqueous solution, considering pKa values of 10 for a protonated amine and 4 for a protonated carboxylic acid.

As the amine is a stronger nucleophile than the acid anion, the less amine exists in solution, the slower the decomposition of acyl halides, leading to larger and less monodisperse KPb₂X₅ NPs. 2) OA and OM also act as ligands capping the surface of the NPs and solubilizing lead halide salts. Their synergistic effect and the ratio to K⁺ and Pb²⁺ regulate the chemical environment of the metal precursor and surface sites in ternary lead halide phases. At a higher concentration of OA the nucleation and growth of the NP slows down, resulting from the decreased reactivity and increased solubility of the metal precursors, and a passivated NP surface. In addition, the increased solubility at high OA concentrations or higher temperature raises the monomer saturation limit, causing Ostwald ripening to dissolve smaller NPs for the growth and increase the final NP size.

### EXAMPLE 3

To further characterize the methods, undoped and doped KPb₂Br₅ and KPb₂(Cl, Br)₅ nanoparticles. For undoped NP synthesis, potassium carbonate (6.9 mg), lead acetate trihydrate (76 mg), 3 mL of OA, 0.5 mL of OM, and 6 mL of ODE were added into a 50 mL 3-neck round bottom flask. In the case of doped NPs, erbium (III) acetate hydrate (0.04 mmol) and ytterbium (III) acetate hydrate (0.4 mmol) were also added. The solution was stirred and degassed on a Schlenk line at 40° C. for 5 min and then degassed at 120° C. for 1 hour. Subsequently, the temperature was increased to 240° C. under nitrogen. 0.3 ml of benzoyl bromide or the mixture of myristoyl chloride/benzoyl bromide (8:2) was swiftly injected. The reaction flask was immediately immersed in an ice-water bath to form KPb₂Br₅ and KPb₂(Cl, Br)₅ nanoparticles. Finally, after adding 5 mL of hexane, the crude solution was centrifuged at 3000 rpm for 5 min. The supernatant was discarded, and the precipitate was redispersed in 5 mL of hexane for further use.

### EXAMPLE 4

To further illustrate the breadth of nanoparticles that can be produced by the methods, KPb₂Cl₅ nanoparticles doped with Nd³⁺ were produced. In a typical synthesis, potassium carbonate (6.9 mg), lead acetate trihydrate (76 mg), 3 mL of OA, 0.5 mL of OM, neodymium (III) acetate hydrate (0.04 mmol) and 6 mL of ODE were added into a 50 mL 3-neck round bottom flask. The solution was stirred and degassed on a Schlenk line at 40° C. for 5 min and then at 120° C. for 1 hour.

Subsequently, the temperature was increased to 260° C. under nitrogen. Upon reaching this temperature, 0.3 mL of myristoyl halide precursor was swiftly injected. The reaction flask was immediately immersed in an ice-water bath. Finally, after adding 5 mL of hexane, the crude solution was centrifuged at 3000 rpm for 5 min. The supernatant was discarded, and the precipitate was redispersed in 5 mL of hexane for further use. Nd³⁺-doped KPb2Cl5 NPs with varying Nd³⁺ concentrations were synthesized following the method described above except the nominal Nd³⁺ amount was varied using values of 0.004, 0.01, 0.04 and 0.10 mmol Nd(CH₃COO)₃·xH₂O.

Synthesis of KPb₂Cl₅ nanoparticles doped with various lanthanide dopants was also conducted. KPb₂Cl₅ NPs with various lanthanide dopants were synthesized following the method described above except the dopant was replaced by the activator Er(CH₃COO)₃·xH₂O, Tm(CH₃COO)₃·xH₂O, Ho(CH₃COO)₃·xH₂O, Pr(CH₃COO)₃ (2% compared to the mole amount of Pb(CH₃COO)₂·3H₂O) and sensitizer ytterbium (III) acetate hydrate (20% compared to the mole amount of Pb(CH₃COO)₂·3H₂O).

### EXAMPLE 5

Undoped NaYF₄ nanoparticles were synthesized using a previously described synthesis, with some modification. To a dry 50 mL 3-neck round bottom flask (1 mmol, 195.3 mg) of YCl₃ were added together with OA (6 mL) and ODE (14 mL). The flask was stirred, placed under vacuum and heated to 100° C. for 1 hour, causing the solution to become clear. The flask was then filled with N₂, and sodium oleate (2.5 mmol, 761.1 mg) and NH₄F (4 mmol, 148.1 mg) were added. The flask was subsequently placed under vacuum and stirred for another 20 min followed by N₂ flushing (3 cycles). The reaction was heated to 315° C. and allowed to react under N₂. After 45 min of reaction time, the flask was rapidly cooled down to room temperature by a strong stream of air, and nanoparticles were isolated with the help of ethanol (20 mL) and centrifugation (3000×g, 5 min). The nanoparticles were additionally washed with hexane:ethanol (1:1 v/v) twice and redispersed in 4 mL of hexane for storage. NaYF₄:20% Yb³⁺, 2% Er³⁺ nanoparticles were prepared in analogous way, by stoichiometrically substituting part of YCl₃ with YbCl₃ and ErCl₃.

### EXAMPLE 6

Analysis of the structure, stability and optical characteristics of the produced nanocrystals was performed. Structures were characterized by TEM images that were obtained with a transmission electron microscope (JEOL 2100F) with an accelerating voltage of 200 kV. Powder X-ray diffraction (XRD) patterns were acquired with a Bruker AXS D8 Discover GADDS X-ray diffractometer, using Co Kα radiation. XPS was measured by K-Alpha Plus XPS/UPS. The actual amounts of the elements were confirmed by elemental analysis using inductively coupled plasma optical emission spectroscopy (Varian ICP-OES 720 Series). For Nd³⁺ doping in KPb₂Cl₅ matrix, the data in FIG. 15 (see Table 3) was fit to a linear regression in order to evaluate the Nd³⁺ doping efficiency as

$$\frac{{[ {Nd}^{3 +} ]}^{ACTUAL}}{{[ {Nd}^{3 +} ]}^{NOMINAL}} \times 100 \% .$$

SEM images were obtained by a tabletop Scanning Electron Microscope.

For moisture stability testing, a powder film of KPb₂Cl₅:Yb³⁺, Er³⁺ NPs with thickness around 0.13 mm was prepared by drop-casting a colloidal suspension of NPs on a glass slide at room temperature. After evaporating the hexane, the film was mounted on a sample holder designed for a FLS980 (Edinburgh Instruments) spectrometer and stored in a sealed plastic box (40 cm×15 cm×15 cm) together with a beaker and a hygrometer. The relative humidity (RH) of 65% and 100% were controlled by the amount of water in the beaker. The upconversion emission of the NPs at 65% and 100% RH was recorded once per week and once every two hours on a FLS980 spectrometer at the same location, respectively.

In situ measurements of upconversion emission stability at ambient conditions and when submerging the sample in water were performed by placing the glass slide with drop casted NPs in a 1×1 cm optical cuvette and recording the upconversion emission under a continuous 980 nm irradiation (101 W/cm²) every 5 minutes over a course of 10 hours.

For optical characterization, upconversion and downshifting emission spectra of Ln³⁺-doped KPb₂X₅ NPs were obtained at room temperature under 800 nm or 980 nm CW laser diode excitation (CNI) and recorded on Edinburgh Instruments FLS980 spectrometer equipped with a double emission monochromator, single-photon counting photomultiplier (Hamamatsu R928), and liquid nitrogen cooled NIR-PMT (Hamamatsu). All spectra were corrected by the system response.

Upconversion photoluminescence lifetime measurements were performed on the same setup modulating the laser diode to obtain 385 μs width pulses with 100 Hz repetition rate. Average lifetime values r were obtained from the integrated area under the photoluminescence decay profiles I(t) measured over time t.

$$τ = {{\int }^{+ ∞}}_{0} \frac{I ( t ) dt}{I ( 0 )}$$

Raman spectra were acquired using a Horiba Jobin Yvon LabRAM ARAMIS confocal microscope with filters purchased from Semrock. Undoped KPb₂X₅ and NaYF₄ NPs were excited with a 532 nm cw laser (Laser Quantum) filtered with a 532 nm long-pass filter. The KPb₂Cl₅:Tm³⁺ NPs were excited with a 785 or 1064 nm cw lasers (Sacher Lasertechnik and Laser Quantum, respectively). To collect downshifting spectra, a 785 nm short-pass filter was used. For upconversion, 1064 nm laser-line filter and 980 nm long-pass filter were used to clean and block the laser beam, respectively, and an 890 nm short-pass filter was used both as a dichroic mirror and as an emission filter. Spectral intensities were corrected for the wavelength dependent instrumental response using a calibrated lamp (Avantes).

Photon-avalanche-like emission of Nd³⁺-doped KPb₂Cl₅ NPs was measured in NP films, prepared by drop casting hexane dispersions with NPs onto 25×25 mm glass coverslips of 0.13 mm thickness. Nd³⁺-doped KPb₂Cl₅ NP films were characterized in ambient conditions (room temperature, air exposure) using a custom-built confocal inverted microscope. The sample was excited by a 1064 nm cw laser source (Opus 1064 3000, Laser Quantum) coupled through a 950 nm short-pass dichroic mirror and a long working distance air objective (60×0.7 NA, Nikon). The emission was collected by the same objective, spectrally filtered using a 950 nm short-pass filter and imaged onto an EMCCD camera (Andor iXon Ultra 897) equipped spectrometer (Acton Research Corp., SpectraPro-300i). Spectral data in the 530-700 nm range was collected from KPb₂Cl₅:17.2% Nd³⁺ NP samples, and that in the 740-950 nm spectral range from KPb₂Cl₅:16.2% Nd³⁺ NP samples.

Representative sample TEM images were evaluated. For power dependence measurements, a continuously variable, reflective neutral density filter wheel (Thorlabs) was inserted into the laser beam path for coarse power selection, and fine power steps were obtained by motorized rotation of a half-wave plate coupled with a Glan-Taylor prism (Thorlabs). Power selection was synchronized and automated with the collection system. Powers were simultaneously recorded by a Thorlabs power meter from a glass cover slip to reflect ˜10% of the incoming flux. Average excitation power densities were calculated using measured laser powers and the 1/e² area calculated for the employed excitation wavelength and microscope objective.

To obtain temporally resolved data, a time correlated single photon counter (TCSPC, HydraHarp 400) was used to tag photon arrival times of collected luminescence with respect to the laser shutoff trigger event. A function generator was used to modulate the laser with square pulses with 5 Hz frequency and 50% duty cycle. The time-resolved luminescence increase curves were fitted with up to two exponential terms. To quantitatively compare luminescence rise-times using a single figure of merit, we calculated the effective rise-time at 95% of the steady-state intensity.

### EXAMPLE 7

The mechanism of the Yb³⁺, Er³⁺ upconversion in KPb₂Cl₅ vs NaYF₄ NPs was evaluated. The steady-state population of each Er³⁺ and Yb³⁺ manifold in NaYF₄ or KPb₂Cl₅ under 980 nm irradiation (100 W/cm²) was calculated through numerical integration of the differential rate equations which account for tens of thousands of simultaneous transitions. Due to the low phonon energies of the KPb₂Cl₅ host matrix, MPR in KPb₂Cl₅:Yb³⁺, Er³⁺ NPs were significantly suppressed compared to NaYF₄:Yb³⁺, Er³⁺. Thus, upon two-step energy transfer upconversion process between Yb³⁺ and Er³⁺, the excitation energy at ⁴F_{7/2} and ²H_{11/2}/⁴S_{3/2} excited states has greater probability to be dissipated as photon emission in KPb₂Cl₅ vs NaYF₄ matrix. On the other hand, red-emitting (660 nm) Er^{3+ 4}F_{9/2} excited state in NaYF₄:Er³⁺, Yb³⁺ is populated primarily by direct ⁴S_{3/2}→⁴F_{9/2} MPR or (⁴I_{13/2}→⁴I_{15/2}:⁴I_{11/2}→⁴F_{9/2}) energy-transfer upconversion between neighboring Er³⁺ ions. This energy transfer upconversion process is highly dependent on the initial ⁴I_{11/2}→⁴I_{13/2} MPR. Both, ⁴S_{3/2}→⁴F_{9/2} and ⁴I_{11/2}→⁴I_{13/2}, MPR processes are greatly suppressed in the low-phonon-energy KPb₂Cl₅ matrix, accounting for the lack of notable red upconversion emission in KPb₂Cl₅:Yb³⁺, Er³⁺ NPs.

Although alternative pathways to populate the ⁴F_{9/2} excited state in KPb₂Cl₅:Yb³⁺, Er³⁺ NPs exist, rates of these processes are several orders of magnitude lower than conventional ⁴F_{9/2} population in NaYF₄:Yb³⁺, Er³⁺ NPs.

The mechanism of the Nd³⁺ photon avalanching KPb₂Cl₅ NPs was also evaluated. The steady-state population of each Nd³⁺ manifold in KPb₂Cl₅ under 1064 nm irradiation of varied power density was modeled. Following the excited state absorption (ESA), two energy-looping motifs among Nd³⁺ ions are identified to give rise to the avalanche upconversion emission. The first motif represents primary energy-looping cross-relaxation (CR) pathways, responsible for the excited state population build-up at the ⁴I_{11/2} manifold. The second motif includes ETU processes that reinforce population of energy states involved in the primary energy-looping group (⁴I_{J/2}, J=11, 13, 15) at the expense of the ⁴F_{3/2} manifold population. The second motif is likely responsible for Nd³⁺ excitation into higher energy levels and could account for the lower slope values of upconversion emission from ⁴F_{3/2} manifold as compared to the ⁴F_{5/2} and ⁴G_{7/2}/⁴G_{9/2}.

Simulation results confirmed the experimental observation of highly nonlinear upconversion emission in KPb₂Cl₅:Nd³⁺ NPs and highlight that these systems can be made even more nonlinear with further NP architectural engineering and [Nd³⁺] optimization. As it stands, the present KPb₂Cl₅:Nd³⁺ NPs show highly nonlinear upconversion emission with nonlinearity factor s>10 and have excited state rise times lengthened up to 70 ms near the avalanching threshold. However, an intensity enhancement factor Δ_{AV}=I(2Pₜₕ)/I(Pₜₕ), where I(Pₜₕ) and I(2Pₜₕ) are emission intensities at threshold power and double the threshold power, respectively, is 102 for the 810 nm transition of KPb₂Cl₅:Nd³⁺ NPs, falling short of the minimum value of 500 to qualify as a true photon avalanche emission. Thus, the luminescence of KPb₂Cl₅:Nd³⁺ NPs conservatively is described as an avalanche-like energy-looping process.

Nonetheless, it appears that low phonon energies of the KPb₂Cl₅ matrix are instrumental for observing highly nonlinear, avalanche-like upconversion from Nd³⁺ ions in NPs. First, by lowering phonon energies, the phonon-assisted ground state absorption of 1064 nm photons becomes less likely, thus increasing the ratio of excited state absorption/ground state absorption rates, which must exceed 10⁴ to be classified as photon avalanching. Second, as indicated in previous analytical modelling, photon avalanching threshold powers scale approximately linearly with the aggregate relaxation rate (W₂) from the lowest excited state of Tm³⁺. Thus, lowering the MPR rate (the major component of W₂) by decreasing the phonon energy of the host should make photon avalanching easier to achieve by lowering the photon avalanching threshold powers. As in NaYF₄:Tm³⁺/NaYF₄ NPs, the population of the first excited state of Nd³⁺ in KPb₂Cl₅ is amplified nonlinearly by cross-relaxation between Nd³⁺ ions. Thus, limiting MPR from this level by leveraging low-phonon-energy host matrices promotes the steeply nonlinear optical response in KPb₂Cl₅:Nd³⁺ NPs.

Due to the low-phonon energies of KPb₂Cl₅ host, we also consider the avalanche-like emission of KPb₂Cl₅:Nd³⁺ NPs to be driven primarily by excited state absorption and cross-relaxation energy looping mechanism, without thermal assistance. Based on previous works, the nanoparticle heating can be calculated as:

$$δ {T}_{NP} = \frac{Q}{4 {πκ}_{s} R}$$

Here, Q is the absorbed power, Kₛ is the thermal conductivity of the surrounding medium, and R is nanoparticle radius. Considering Kₛ=0.025 W·m⁻¹·K⁻¹ (air), the maximum laser power 0.6 mW and the absorbance of 100-nm-sized KPb₂Cl₅:Nd³⁺ NPs to be close to 10⁻⁵, conservatively estimating the nanoparticle heating to be on the order of 0.4° C., too low to provide significant thermal assistance.

### EXAMPLE 8

To illustrate the intrinsic bistability of the materials, KPb₂Cl₅:Nd³⁺ nanocrystals were fabricated and evaluated. KPb₂X₅ (X═Cl, Br) matrices have some of the lowest host phonon energies available, which results in markedly reduced quenching of Ln³⁺ excited states and has led us to uncover PA emission in Nd³⁺ dopants at room temperature. It was reasoned that even greater optical nonlinearities, and possibly IOB, could be realized with KPb₂Cl₅:Nd³⁺ ANPs at cryogenic temperatures, which suppress thermal phonons and further reduces multiphonon relaxation (MPR) rates by several orders of magnitude.

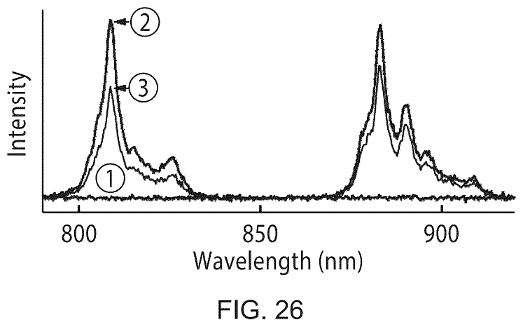

The KPb₂Cl₅ (16 mol % Nd³⁺) ANP materials at 77 K were optically characterized and it was observed a sharp increase in luminescence intensity (measured at 810 nm) when the 1064 nm pump reached a threshold value of 6.7 kW·cm⁻² as shown in FIG. 24. By fitting the linear region of the power-dependent luminescence curve at the switch-on threshold, the nonlinearity of the emission equivalent to 200-photon process (s=200) was measured. In addition to this extraordinary nonlinearity, it was observed that the luminescence of KPb₂Cl₅:Nd³⁺ ANPs did not cease until we reduced the pump power to 4.2 KW·cm⁻² below the switch-on threshold, at which point the ANPs became dark (FIG. 24). Such a power-dependent luminescence hysteresis is a distinctive feature of IOB. The luminescence hysteresis of KPb₂Cl₅:Nd³⁺ ANPs was confirmed using two different detectors (avalanche photodiode, spectrometer) and on two different substrates. Spectrally, the two stable states of KPb₂Cl₅:Nd³⁺ ANPs are seen via Nd³⁺ emission lines at 810 nm (⁴F_{5/2}→⁴I_{9/2}) and 880 nm (⁴F_{3/2}→⁴I_{9/2}) (FIG. 26). At a 1064 nm pump of 5 kW·cm⁻² power, ANPs were either dark or bright, depending whether the spectra were acquired before or after the switch-on threshold.

To understand the underlying conditions for IOB, the Nd³⁺ concentration in KPb₂Cl₅ nanocrystals KPb₂Cl₅:Nd³⁺ was varied and the PA and luminescence hysteresis were evaluated. These were found predominantly in samples with [Nd³⁺]→4 mol %. To understand the underlying conditions for IOB, the Nd³⁺ concentration in KPb₂Cl₅ nanocrystals KPb₂Cl₅:Nd³⁺ was varied and the PA and luminescence hysteresis were evaluated. These were found predominantly in samples with [Nd³⁺]>4 mol %. This indicated that the nonlinearity for the IOB is provided by a PA process, which is a concentration-dependent positive feedback loop of excited state absorption (ESA) and inter-ion cross-relaxation. Furthermore, Nd3+ ions doped in a higher phonon energy host, i.e., NaYF₄, did not exhibit PA (or luminescence hysteresis) even when cooled to liquid helium temperatures. This highlighted the need for low-phonon-energy hosts to observe the IOB, as cryogenic temperatures alone are insufficient to promote nonlinear Nd³⁺ luminescence.

The pump power dependence of multiple spots across the KPb₂Cl₅:Nd³⁺ sample was also measured to obtain statistical information about the reproducibility of IOB and its characteristics: switch-on threshold, hysteresis width, and intensity contrast (FIG. 26). It was found that the average switch-on power density was 5.2 KW·cm⁻², corresponding to 64 μW pump power, which is appropriate for low operating power requirements (μW-mW) in optical computing. On average, luminescence was sustained at about 1 KW·cm⁻² below the switch-on threshold, and the intensity contrast was around 35 dB (defined as signal-to-noise ratio [SNR] at the switch-on threshold), which is important for unambiguous discrimination between bright and dark states of KPb₂Cl₅:Nd³⁺ luminescence.

To demonstrate the robustness of IOB in the KPb₂Cl₅:Nd³⁺ ANPs, the optical hysteresis measurements on the same spot (represented in FIG. 25) were repeated over 100 times under continuous 1064 nm pump over a 12 hour period. Despite minor variations in the switch-on threshold and hysteresis width caused by the sample drift, the IOB behavior could be accurately reproduced in each power sweep cycle. The same luminescence hysteresis was registered at different signal acquisition dwell times (0.01-10 s) per set power value, implying that IOB in KPb₂Cl₅:Nd³⁺ ANPs is not thermal in nature.

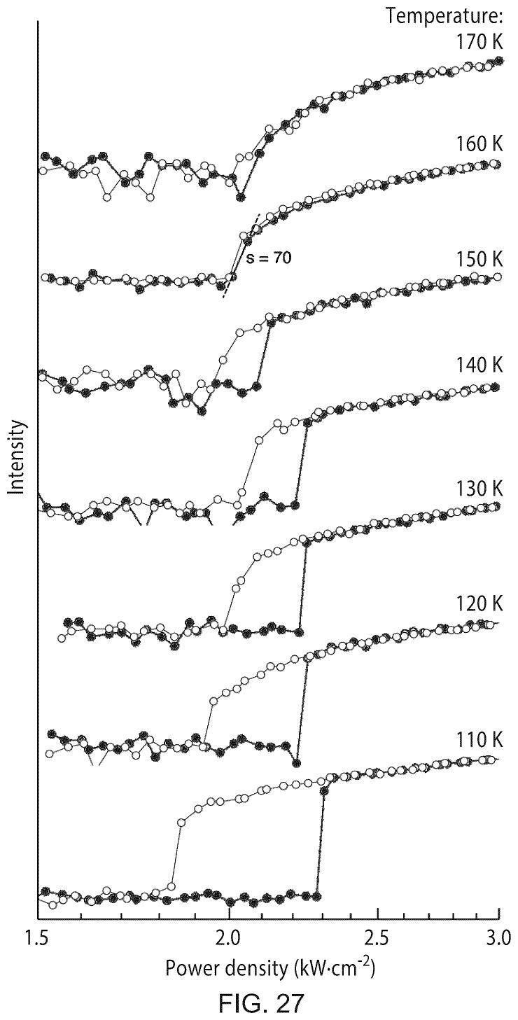

The impact of quenching of excited states by thermal photons through temperature-dependent measurements of IOB in KPb₂Cl₅:Nd³⁺ ANPs was observed. The power-dependent luminescence of ANPs was measured at different temperatures and found that higher temperatures lead to a lower degree of nonlinearity and narrowing of luminescence hysteresis width as shown in FIG. 27. Importantly, the IOB of the KPb₂Cl₅:Nd³⁺ ANPs was observed even at temperatures as high as 150 K (FIG. 27). The switch-on threshold also shifted to lower values with increasing temperatures, which attests to a more efficient phonon-assisted ground state absorption (GSA). Notably, at 160 K, the ANPs did not show luminescence hysteresis despite their luminescence still being extremely nonlinear (s=70), suggesting that nominal nonlinearities above the 100-photon process are required to induce IOB in the KPb₂Cl₅:Nd³⁺ ANPs.

### EXAMPLE 9

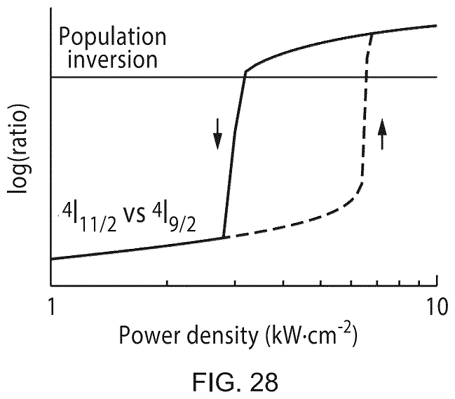

The mechanism of the Intrinsic optical bistability (IOB) of the KPb₂Cl₅:Nd³⁺ ANP material was evaluated. To understand the mechanism by which IOB emerges in KPb₂Cl₅:Nd³⁺ ANPs, a coupled differential rate equation model was used, which numerically evaluates the population of 4f^{N} energy states of Nd³⁺ ions under a 1064 nm pump. To replicate luminescence dependence on the power history, the population of Nd³⁺ states was simulated at each power density value, starting from the population obtained at the previous value. Given this condition, we successfully simulated the nonlinear power scaling of KPb₂Cl₅:Nd³⁺ luminescence and, most importantly, the pump-dependent luminescence hysteresis. The model also exposed a population inversion (PI) between the ground (⁴I_{9/2}) and the first excited (⁴I_{11/2}) states of Nd³⁺ ions at the switch-on pump threshold, which was maintained at powers below that threshold as shown in FIG. 28.

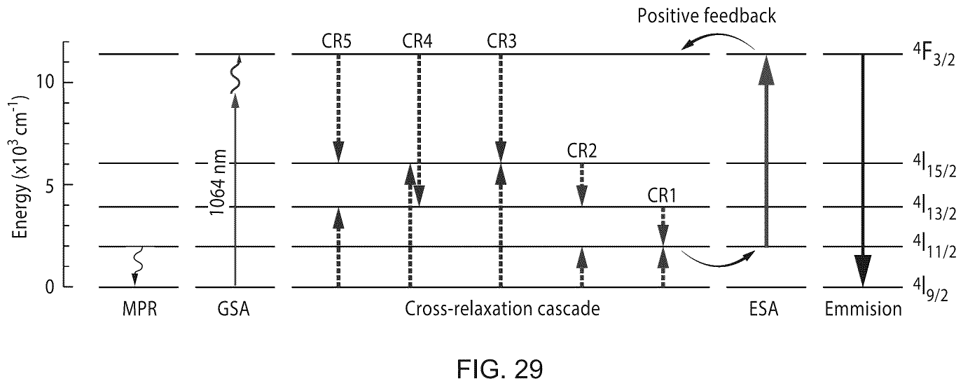

Although cross-relaxations from the ⁴F_{3/2} excited state (CR3-5 in FIG. 29) were not essential to establish PI, in their absence the switch-on threshold shifted to higher values. It is believed that these pathways help repopulate lower Nd³⁺ excited states (⁴I_{11/2}, ⁴I_{13/2}, ⁴I_{15/2}) after photon absorption and contribute to the nonlinear behavior of ANPs through a cross-relaxation cascade.

Finally, the rate of CR1 in the wild-type (WT—no knock-outs) KPb₂Cl₅:Nd³⁺ Qa was compared to that of other transitions and it was found that within the bistable region of luminescence, the rate of CR1 is greater than the rate of quenching of the ⁴I_{11/2} energy level via MPR. Thus the dark and bright states of KPb₂Cl₅:Nd³⁺ ANPs (FIG. 24) with Nd³⁺ dopants are associated with being predominantly populated in their ground or first excited states, respectively. The PI is linked to the appearance of the bright state of KPb₂Cl₅:Nd³⁺ ANPs, wherein the positive feedback (CR1+ESA) acts as a latch that resists quenching of ⁴I_{11/2} energy level by MPR and leads to IOB. Based on these results, it should be emphasized that IOB in KPb₂Cl₅:Nd³⁺ ANPs is an all-optical, nonthermal phenomenon, clearly distinguishing this system from thermally-induced IOB in Yb³⁺-(co)doped materials.

### EXAMPLE 10

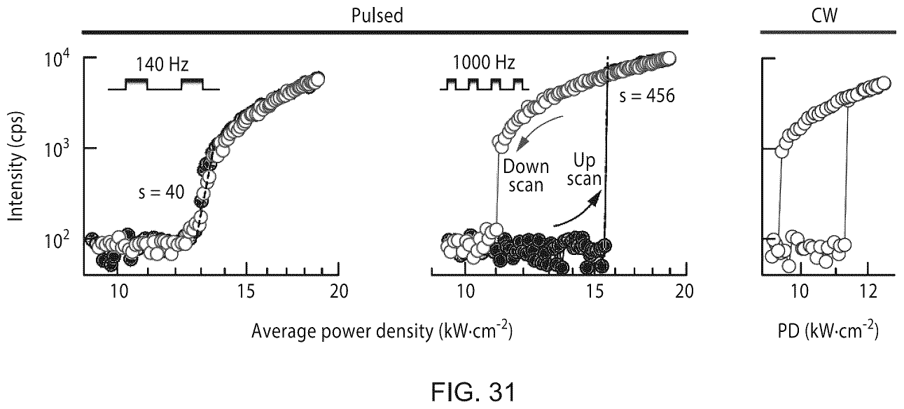

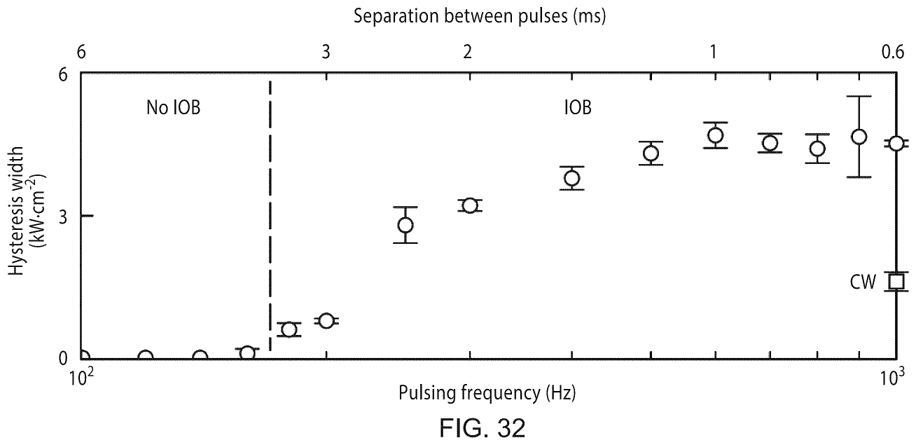

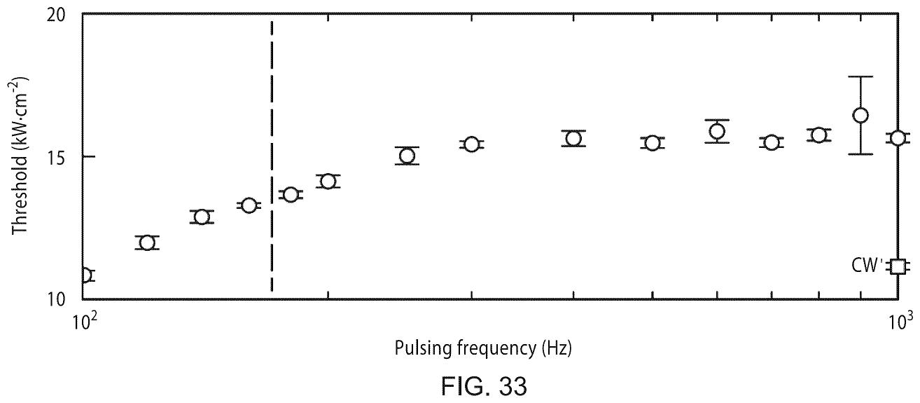

The capabilities of the materials for temporal modulation were also evaluated. Given the dynamic nature of the PA mechanism, it was hypothesized that the PI between Nd³⁺ energy levels and, subsequently, the IOB could be controlled by temporal pump laser modulation. When the frequency and duty cycle of a pulsed 1064 nm excitation were varied, it was observed that IOB in KPb₂Cl₅:Nd³⁺ ANPs can be selectively inhibited or induced, and the characteristics of luminescence hysteresis can be varied as shown in FIG. 31, FIG. 32 and FIG. 33. Compared to continuous wave (CW) 1064 nm excitation, under slow pulsing (<170 Hz, 40% duty cycle) the hysteresis loop was closed entirely, and PA threshold and nonlinearity decreased (s=40 at 140 Hz) as seen in FIG. 31.

In contrast, higher pulse frequencies (and lower duty cycles) shifted the PA threshold to higher average powers (FIG. 33) and widened the hysteresis (FIG. 32). At 1000 Hz pump frequency, hysteresis width was 4.5 kW·cm⁻² (and 24 KW·cm⁻² at 10% duty cycle compared to 1.6 KW·cm⁻² for the same spot at CW. The shift of switch-on powers to higher values can be rationalized by the decreased probability of GSA with decreasing pulse energies (25 nJ at 100 Hz vs. 3.6 nJ at 1000 Hz).

Similarly, higher pulse frequencies result in shorter periods between pulses, at which point positive feedback of ESA+CR1 can maintain PI. Based on the frequencies at which KPb₂Cl₅:Nd₃₊ ANPs start to exhibit luminescence hysteresis (180 Hz and 300 Hz at 40% and 10% duty cycle, respectively), the coherence time of the PI in Nd₃₊ ions was estimated to be around 3 ms, which is similar to the lifetime of ⁴I_{11/2} excited state (2.3 ms at room temperature.

The on-demand control over the switch-on power threshold, hysteresis width, and nonlinearity of the bistable KPb₂Cl₅:Nd³⁺ ANPs underscores their utility in different photonic applications. For example, a variable degree of nonlinearity is useful for reconfigurable photonic neural networks to adjust neuron activation functions.

### EXAMPLE 11

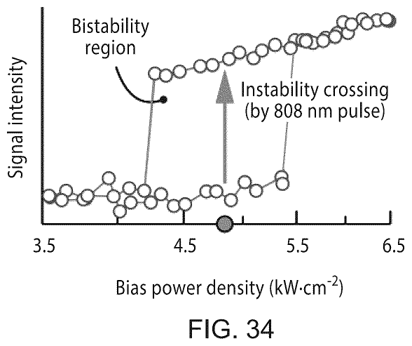

Optical switching via instability crossing was demonstrated. Inspired by the possibility of inducing and controlling IOB in KPb₂Cl₅:Nd³⁺ ANPs, we sought to demonstrate how their bistable response can be used for optical switching and memory. Similar to addressing a transistor, two inputs of different wavelengths were used to excite the bistable ANPs: 1) a brief (few seconds) 808 nm control pulse to induce luminescence and 2) a constant 1064 nm excitation to maintain it. It was hypothesized that the control pulse, resonant with GSA (⁴I_{9/2}→⁴F_{3/2}) of Nd³⁺ ions, would facilitate switching from a dark to a bright state (which is termed as instability crossing; FIG. 34), at which point the bias of 1064 nm excitation would latch onto the bright state by initiating the positive feedback of ESA and cross-relaxation (i.e., PA).

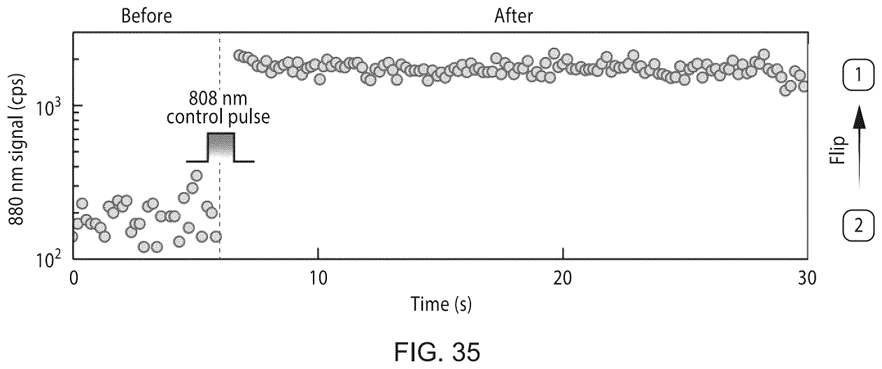

Subsequently, it was shown how luminescence (measured at 880 nm) of KPb₂Cl₅:Nd³⁺ ANPs could be easily flipped from 0 (dark) to 1 (bright) states after 808 nm control pulse and maintained as long as the 1064 nm excitation was present (FIG. 35). Notably, the transition between the two stable states was achieved at extremely low 808 nm power density (7 W·cm⁻², corresponding to 75 nW power).

In control experiments, a 1064 nm bias was applied outside of the bistable region and it was found that the luminescence of KPb₂Cl₅:Nd³⁺ ANPs does not change after 808 nm control input. Similar instability crossing experiments were performed under a pulsed 1064 nm excitation of different average power densities and using control laser wavelengths resonant with other GSA transitions of Nd³⁺ ions.

It was noted that latching onto the bright state of KPb₂Cl₅:Nd³⁺ ANPs via ESA, following a GSA-induced instability crossing from a dark to a bright state, decisively proves the nonthermal nature of IOB of KPb₂Cl₅:Nd³⁺ ANPs. Critically, using two lasers to address the bistable ANPs avoids changing the pump power of the 1064 nm laser to reach the bright state and bypasses the long rise times associated with establishing a photon avalanche.

In sum, an extraordinarily nonlinear and bistable luminescence of KPb₂Cl₅:Nd³⁺ nanocrystals were demonstrated, which was enabled by suppressing phonon quenching and promoting nonlinear interactions between Nd³⁺ dopants. In contrast to other Ln³⁺-doped materials that exhibit intrinsic optical bistability, the bistability of KPb₂Cl₅:Nd³⁺ ANPs stems from the nonthermal photon avalanche phenomenon. Subsequently, it was shown that this allows tuning of IOB characteristics, optical switching, and memory with KPb₂Cl₅:Nd³⁺ ANPs. These results set a precedent for investigating other Ln³⁺ -doped ANPs that display intrinsic optical bistability.

The bistable KPb₂Cl₅:Nd³⁺ ANPs also meet the criteria for constructing optical logic, namely, cascadability, fan-out, logic-level restoration, and absence of critical biasing. The cascadability of optical components is an outstanding challenge that could be addressed with Ln³⁺-doped optical switches, e.g., KPb₂Cl₅:Nd³⁺ ANPs emit 810 nm light under 1064 nm excitation and vice versa. Accordingly, one such optical switch could activate another in a network of interconnected nanomaterials.

Furthermore, solution processing and direct lithography methods can facilitate the fabrication of 3D volumetric interconnects from bistable ANPs for high-density optical memory. Such nanoscale optical devices are essential to realize optical signal amplification, logic gates, flip-flop operations, random access memory, and analog-to-digital conversion, building on and complementing the semiconductor electronics.

Materials with even lower phonon energies, e.g., KPb₂Br₅, which could facilitate IOB at even milder temperatures, accessible by thermoelectric cooling. Developing cascadable networks of bistable nanocrystals will facilitate high-throughput optical data handling with possible on-chip integration and operation at silicon band-gap and telecommunication wavelengths.

From the description herein, it will be appreciated that the present disclosure encompasses multiple implementations of the technology which include, but are not limited to, the following:

A composition comprising KPb₂X₅ nanoparticles, where X is a halogen, wherein the nanoparticles are stable at ambient relative humidity conditions and exhibit low phonon energies.

The composition of any preceding or following implementation, wherein X is selected from the group of Cl, Br, I and a combination of Cl and Br.

The composition of any preceding or following implementation, wherein the nanoparticles are selected from the group of KPb₂Cl₅, KPb₂Br₅, and KPb₂(Br_{y}Cl_{1-y})₅, where y ranges between 0 and 1.

The composition of any preceding or following implementation, wherein the nanoparticles are selected from the group of KPb₂Cl₅, KPb₂(Br_{0.375}Cl_{0.625})₅, and KPb₂Br₅.

The composition of any preceding or following implementation, wherein a diameter dimension of the nanoparticles is about 1 nanometer to about 500 nanometers.

The composition of any preceding or following implementation, wherein a diameter dimension of the nanoparticles is about 40 nanometers to about 55 nanometers.

The composition of any preceding or following implementation, the nanoparticles further comprising at least one lanthanide dopant.

The composition of any preceding or following implementation, wherein the lanthanide dopant is selected from the group of dopants consisting of La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, and Lu³⁺, and combinations thereof.

The composition of any preceding or following implementation, wherein the nanoparticles have an actual lanthanide dopant concentration of between about 0 mol. % and about 100 mol %.

The composition of any preceding or following implementation, wherein the nanoparticles have an actual lanthanide dopant concentration of between about 0.4 mol. % and about 4.1 mol %.

A method for producing low phonon energy nanoparticles, the method comprising: (a) preparing a solution of Pb(OAc)₄, K₂CO₃, oleylamine (OM), oleic acid (OA), and octadecene (ODE); (b) heating the solution to a temperature of between about 100° C. and about 310° C.; (c) injecting an acyl halide into the heated solution; (d) immediately cooling the injected solution to promote the growth of KPb₂X₅ nanoparticles, where X is a halogen; and (e) collecting the nanoparticles.

The method of any preceding or following implementation, wherein the acyl halide is selected from the group comprising myristoyl chloride, benzoyl bromide and a mixture of myristoyl chloride with benzoyl bromide.

The method of any preceding or following implementation, wherein X is selected from the group of Cl, Br, I and a combination of Cl and Br.

The method of any preceding or following implementation, further comprising controlling the temperature of the heated solution at the time of injection to control nanoparticle size.

The method of any preceding or following implementation, further comprising controlling the ratio of OA/OM to tune nanoparticle size distributions.

The method of any preceding or following implementation, wherein the OA/OM ratio is selected from the group consisting of 1:6, 1:3, 1:2, 1:1.35 and 1:1.

The method of any preceding or following implementation, wherein a diameter dimension of produced nanoparticles is in the range of about 8 nanometers to about 155 nanometers.

The method of any preceding or following implementation, further comprising adding at least one lanthanide dopant to the prepared solution; wherein low phonon energies of KPb₂X₅ nanoparticles promote upconversion luminescence from higher lanthanide excited states and enable highly nonlinear, avalanche-like emission from lanthanide doped KPb₂X₅ nanoparticles.

The method of any preceding or following implementation, wherein the lanthanide dopant is selected from the group of dopants consisting of La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, Lu³⁺, and combinations thereof.

The method of any preceding or following implementation, wherein a nominal dopant concentration added to the solution is in the range of about 0 mol % to about 100 mol %.

The method of any preceding or following implementation, wherein a nominal dopant concentration added to the solution is in the range of about 2 mol % to about 30 mol %.

The method of any preceding or following implementation, further comprising adding at least one activator N(CH₃COO)₃·xH₂O where N is a lanthanide selected from the group of Er, Tm, Ho, and Pr to the prepared solution.

A method for producing low phonon energy nanoparticles, the method comprising: (a) preparing a solution of Pb(OAc)₄, K₂CO₃, oleylamine (OM), oleic acid (OA), octadecene (ODE) and a lanthanide dopant; (b) controlling a ratio of OA/OM to tune nanoparticle size distributions; (c) heating the solution to a temperature of between about 100° C. and about 310° C.; (d) selecting the temperature of the heated solution to control nanoparticle size; (e) injecting an acyl halide into the heated solution selected from the group of myristoyl chloride, benzoyl bromide and a mixture of myristoyl chloride with benzoyl bromide; (f) immediately cooling the injected solution to promote the growth of lanthanide doped KPb₂X₅ nanoparticles, where X is Cl or Br; and (g) collecting the nanoparticles; (h) wherein low phonon energies of KPb₂X₅ nanoparticles promote upconversion luminescence from higher lanthanide excited states and enable highly nonlinear, avalanche-like emission from lanthanide doped KPb₂X₅ nanoparticles.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to +10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
Nominal vs actual doping concentration of Yb³⁺ and
Er³⁺ in KPb₂Cl₅:Yb³⁺, Er³⁺ NPs with varied [Yb³⁺].
Mol % is presented assuming substitution of
either of Pb sites in KPb₂Cl₅ crystal.

| | Nominal | Actual | Nominal | Actual |
|---|---|---|---|---|
| KPb₂Cl₅:Yb³⁺, | [Er³⁺], | [Er³⁺], | [Yb³⁺], | [Yb³⁺], |
| Er³⁺ sample | mol % | mol % | mol % | mol % |
| 1 | 2 | 0.60 | 5 | 0.62 |
| 2 | 2 | 0.58 | 10 | 0.94 |
| 3 | 2 | 0.55 | 20 | 2.87 |
| 4 | 2 | 0.73 | 30 | 2.82 |

TABLE 2
Nominal vs actual doping concentration of Yb³⁺ and Er³⁺ in KPX:Yb³⁺, Er³⁺
NPs. Mol % is presented assuming substitution of either of Pb sites in KPX crystal.

| | Nominal | Actual | Nominal | Actual |
|---|---|---|---|---|
| Sample name | [Er³⁺], mol % | [Er³⁺], mol % | [Yb³⁺], mol % | [Yb³⁺], mol % |
| KPb₂C₁₅:Yb³⁺, Er³⁺ | 2 | 0.55 | 20 | 2.87 |
| KPb₂(Br_{0.375}Cl_{0.625})₅:Yb³⁺, Er³⁺ | 2 | 0.18 | 20 | 0.28 |
| KPb₂Br₅:Yb³⁺, Er³⁺ | 2 | 0.03 | 20 | not detected |

TABLE 3
Nominal vs actual doping concentration of Nd³⁺ in
KPb₂Cl₅ NPs with varied [Nd³⁺]. Mol % is presented assuming
substitution of either of Pb sites in KPb₂Cl₅ crystal.

| KPb₂Cl₅:Nd³⁺ | Nominal | Actual |
|---|---|---|
| sample | [Nd³⁺], mol % | [Nd³⁺], mol % |
| 1 | 1 | 0.36 |
| 2 | 2 | 0.87 |
| 3 | 5 | 1.85 |
| 4 | 10 | 4.14 |

What is claimed is:

1. A composition comprising:
KPb₂X₅ nanoparticles, where X is a halogen;
wherein said nanoparticles are stable at ambient relative humidity conditions.

2. The composition of claim 1, wherein X is selected from the group of Cl, Br, I and a combination of Cl and Br.

3. The composition of claim 1, wherein said nanoparticles are selected from the group of KPb₂Cl₅, KPb₂(Br_{0.375}Cl_{0.625})₅, and KPb₂Br₅ and KPb₂(Br_{y}Cl_{1-y})₅, where y ranges between 0 and 1.

4. The composition of claim 1, wherein a diameter dimension of the nanoparticles is about 1 nanometer to about 500 nanometers.

5. The composition of claim 1, said nanoparticles further comprising at least one lanthanide dopant.

6. The composition of claim 5, wherein said lanthanide dopant is selected from the group of dopants consisting of La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, Lu³⁺ and combinations thereof.

7. The composition of claim 5, wherein said nanoparticles have an actual lanthanide dopant concentration of between about 0.4 mol. % and about 4.1 mol %.

8. A method for producing low phonon energy nanoparticles, the method comprising:
(a) preparing a solution of Pb(OAc)₄, K₂CO₃, oleylamine (OM), oleic acid (OA), and octadecene (ODE);
(b) heating the solution to a temperature of between about 100° C. and about 310° C.;
(c) injecting an acyl halide into the heated solution;
(d) immediately cooling the injected solution to promote the growth of KPb₂X₅ nanoparticles, where X is a halogen; and
(e) collecting the nanoparticles.

9. The method of claim 8, wherein any molecule from the general class of acyl halides is selected from the group of myristoyl chloride, benzoyl bromide, and mixtures of acyl halides.

10. The method of claim 8, wherein X is selected from the group of Cl, Br, I and a combination of Cl and Br.

11. The method of claim 8, wherein the acyl halide is selected from the group comprising myristoyl chloride, benzoyl bromide and a mixture of myristoyl chloride with benzoyl bromide.

12. The method of claim 8, further comprising:
controlling the temperature of the heated solution at the time of injection to control nanoparticle size.

13. The method of claim 8, further comprising:
controlling a ratio of OA/OM to tune nanoparticle size distributions.

14. The method of claim 13, wherein the OA/OM ratio is selected from the group consisting of 1:6, 1:3, 1:2, 1:1.35 and 1:1.

15. The method of claim 8, wherein a diameter dimension of produced nanoparticles is in the range of about 8 nanometers to about 155 nanometers.

16. The method of claim 8, further comprising:
adding at least one lanthanide dopant to the prepared solution;
wherein low phonon energies of KPb₂X₅ nanoparticles promote upconversion luminescence from higher lanthanide excited states and enable highly nonlinear, avalanche-like emission from lanthanide doped KPb₂X₅ nanoparticles.

17. The method of claim 16, wherein said lanthanide dopant is selected from the group of dopants consisting of La³⁺, Ce³⁺, Pr³⁺, Nd³⁺, Sm³⁺, Eu³⁺, Gd³⁺, Tb³⁺, Dy³⁺, Ho³⁺, Er³⁺, Tm³⁺, Yb³⁺, Lu³⁺ and combinations thereof.

18. The method of claim 16, wherein a nominal dopant concentration added to said solution is in the range of about 2 mol % to about 30 mol %.

19. The method of claim 8, further comprising:
adding at least one activator N(CH₃COO)₃·xH₂O where N is a lanthanide selected from the group of Er, Tm, Ho, and Pr to the prepared solution.

20. A method for producing low phonon energy nanoparticles, the method comprising:
(a) preparing a solution of Pb(OAc)₄, K₂CO₃, oleylamine (OM), oleic acid (OA), octadecene (ODE) and a lanthanide dopant;
(b) controlling a ratio of OA/OM to tune nanoparticle size distributions;
(c) heating the solution to a temperature of between about 100° C. and about 310° C.;
(d) selecting the temperature of the heated solution to control nanoparticle size;
(e) injecting an acyl halide into the heated solution selected from the group of myristoyl chloride, benzoyl bromide and a mixture of myristoyl chloride with benzoyl bromide;
(f) immediately cooling the injected solution to promote the growth of lanthanide doped KPb₂X₅ nanoparticles, where X is Cl or Br; and
(g) collecting the nanoparticles;
(h) wherein low phonon energies of KPb₂X₅ nanoparticles promote upconversion luminescence from higher lanthanide excited states and enable highly nonlinear, avalanche-like emission from lanthanide doped KPb₂X₅ nanoparticles.
